(19) United States
(12) Patent Application Publication
(10) Pub. No.: US 2023/0068150 A1
(43) Pub. Date: Mar. 2, 2023

(54) COMPUTER-READABLE RECORDING MEDIUM STORING INFORMATION PROCESSING PROGRAM AND INFORMATION PROCESSING METHOD

(71) Applicant: FUJITSU LIMITED, Kawasaki-shi (JP)

(72) Inventor: Yusuke Nagasaka, Kawasaki (JP)

(73) Assignee: FUJITSU LIMITED, Kawasaki-shi (JP)

(21) Appl. No.: 17/748,086

(22) Filed: May 19, 2022

(30) Foreign Application Priority Data
Aug. 24, 2021 (JP) 2021-136692

(51) Int. Cl. G06F 17/16; G06F 7/523

(52) U.S. Cl. CPC G06F 17/16; G06F 7/523

(57) ABSTRACT

A non-transitory computer-readable recording medium stores an information processing program for causing a computer to execute processing including: acquiring first data that enables, for each of non-zero elements included in multidimensional tensor data, specification of a combination of a value of the element and an index of each dimension that indicates a position of the element; generating, on the basis of the acquired first data, second data that enables specification of a plurality of groups obtained by grouping each of the combinations such that the combinations with indexes that overlap with each other are included in different groups; and performing, on the basis of the generated second data, matricized tensor times khatri-rao product (MTTKRP) processing by setting each combination of a plurality of combinations included in the group as a target of parallel processing in the MTTKRP processing related to the tensor data.

### CROSS-REFERENCE TO RELATED APPLICATION

This application is based upon and claims the benefit of priority of the prior Japanese Patent Application No. 2021-136692, filed on Aug. 24, 2021, the entire contents of which are incorporated herein by reference.

### FIELD

The embodiment discussed herein is related to an information processing program, an information processing method, and an information processing apparatus.

### BACKGROUND

Conventionally, there is a technology for analyzing, by decomposing multidimensional data called a tensor, characteristics of the multidimensional data. For example, there is a technology called alternating least squares (ALS) for analyzing characteristics of multidimensional data.

Japanese Laid-open Patent Publication No. 2016-139391, International Publication Pamphlet No. WO 2019/244804, Japanese Laid-open Patent Publication No. 2016-119084, and Japanese Laid-open Patent Publication No. 2019-148969 are disclosed as related art.

### SUMMARY

According to an aspect of the embodiments, a non-transitory computer-readable recording medium stores an information processing program for causing a computer to execute processing including: acquiring first data that enables, for each of non-zero elements included in multidimensional tensor data, specification of a combination of a value of the element and an index of each dimension that indicates a position of the element; generating, on the basis of the acquired first data, second data that enables specification of a plurality of groups obtained by grouping each of the combinations such that the combinations with indexes that overlap with each other are included in different groups; and performing, on the basis of the generated second data, matricized tensor times khatri-rao product (MTTKRP) processing by setting each combination of a plurality of combinations included in the group as a target of parallel processing in the MTTKRP processing related to the tensor data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating one example of an information processing method according to an embodiment;

FIG. 2 is an explanatory diagram illustrating one example of a canonical polyadic decomposition (CPD) calculation system 200;

FIG. 3 is a block diagram illustrating a hardware configuration example of an information processing apparatus 100;

FIG. 4 is a block diagram illustrating a functional configuration example of the information processing apparatus 100 according to a first operation example;

FIG. 5 is an explanatory diagram (part 1) illustrating the first operation example of the information processing apparatus 100;

FIG. 6 is an explanatory diagram (part 2) illustrating the first operation example of the information processing apparatus 100;

FIG. 7 is an explanatory diagram (part 3) illustrating the first operation example of the information processing apparatus 100;

FIG. 8 is an explanatory diagram (part 4) illustrating the first operation example of the information processing apparatus 100;

FIG. 9 is an explanatory diagram (part 5) illustrating the first operation example of the information processing apparatus 100;

FIG. 10 is an explanatory diagram (part 6) illustrating the first operation example of the information processing apparatus 100;

FIG. 11 is an explanatory diagram (part 7) illustrating the first operation example of the information processing apparatus 100;

FIG. 12 is an explanatory diagram (part 8) illustrating the first operation example of the information processing apparatus 100;

FIG. 13 is an explanatory diagram (part 9) illustrating the first operation example of the information processing apparatus 100;

FIG. 14 is an explanatory diagram (part 10) illustrating the first operation example of the information processing apparatus 100;

FIG. 15 is an explanatory diagram (part 11) illustrating the first operation example of the information processing apparatus 100;

FIG. 16 is an explanatory diagram (part 12) illustrating the first operation example of the information processing apparatus 100;

FIG. 17 is an explanatory diagram (part 13) illustrating the first operation example of the information processing apparatus 100;

FIG. 18 is a flowchart illustrating one example of a first classification processing procedure in the first operation example;

FIG. 19 is a flowchart illustrating one example of a second classification processing procedure in the first operation example;

FIG. 20 is a flowchart illustrating one example of a calculation processing procedure in the first operation example;

FIG. 21 is a block diagram illustrating a functional configuration example of the information processing apparatus 100 according to a second operation example;

FIG. 22 is an explanatory diagram (part 1) illustrating the second operation example of the information processing apparatus 100;

FIG. 23 is an explanatory diagram (part 2) illustrating the second operation example of the information processing apparatus 100;

FIG. 24 is an explanatory diagram (part 3) illustrating the second operation example of the information processing apparatus 100;

FIG. 25 is an explanatory diagram (part 4) illustrating the second operation example of the information processing apparatus 100;

FIG. 26 is an explanatory diagram (part 5) illustrating the second operation example of the information processing apparatus 100;

FIG. 27 is an explanatory diagram (part 6) illustrating the second operation example of the information processing apparatus 100;

FIG. 28 is an explanatory diagram (part 7) illustrating the second operation example of the information processing apparatus 100;

FIG. 29 is an explanatory diagram (part 8) illustrating the second operation example of the information processing apparatus 100;

FIG. 30 is an explanatory diagram (part 9) illustrating the second operation example of the information processing apparatus 100;

FIG. 31 is a flowchart illustrating one example of a preparation processing procedure;

FIG. 32 is a flowchart illustrating one example of a calculation processing procedure;

FIG. 33 is a flowchart illustrating one example of a parallel calculation processing procedure; and

FIG. 34 is a flowchart illustrating one example of a sequential calculation processing procedure.

### DESCRIPTION OF EMBODIMENTS

For example, there is a technology for performing, for N-dimensional tensor data, a loop calculation for a plurality of indexes of the tensor data. Furthermore, for example, there is a technology for updating a plurality of factor matrices as a set of factor matrices capable of parallel processing. Furthermore, for example, there is a technology for creating a partitioned compressed representation of a matrix including a mapping array including listings. Furthermore, for example, there is a technology for extracting, from each first row included in a matrix, a pair of a value of a non-zero element and a column identifier and adding a dummy pair with a value of zero for a first row that includes fewer non-zero elements than the maximum value.

However, in the prior arts, there is a problem that increase in calculation time is incurred when multidimensional data is decomposed. For example, among calculations in the ALS, a calculation called matricized tensor times khatri-rao product (MTTKRP) handles a huge matrix, which tends to incur increase in calculation time and memory usage. Furthermore, when it is attempted to reduce the calculation time by parallelizing matrix operations, different operations may conflict with each other.

In one aspect, an embodiment aims to shorten calculation time taken for MTTKRP processing.

Hereinafter, an embodiment of an information processing program, an information processing method, and an information processing apparatus will be described in detail with reference to the drawings.

(One Example of Information Processing Method According to Embodiment)

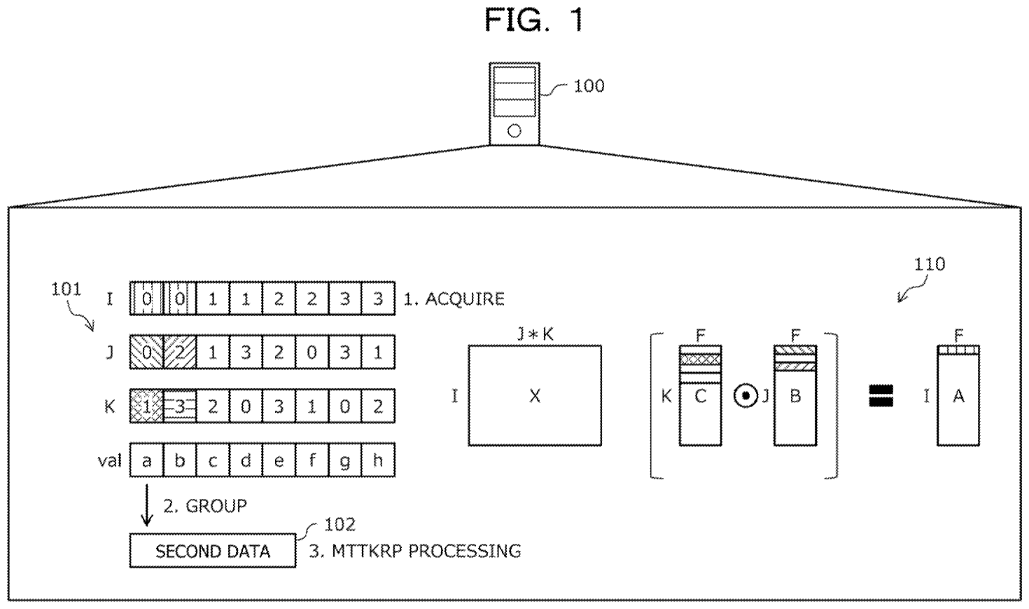

FIG. 1 is an explanatory diagram illustrating one example of the information processing method according to the embodiment. An information processing apparatus 100 is a computer for facilitating analysis of tensor data. The information processing apparatus 100 is, for example, a server or a personal computer (PC).

The tensor data is multidimensional data. The tensor data includes a plurality of elements. The element is associated with an index of each dimension. The tensor data may have sparsity, for example. The sparsity is a property that there are relatively many zero elements and relatively few non-zero elements among the plurality of elements included in the tensor data.

Here, it may be desired to analyze characteristics of the tensor data. Conventionally, there is a method of analyzing characteristics of tensor data by decomposing the tensor data. For example, there is a method called canonical polyadic decomposition (CPD).

For example, it is assumed that tensor data X is third order tensor data and X=R^{(I}×^{J}×^{K)}. Here, it is assumed that a matrix A=R^{(I}×^{F)} is defined, a matrix B=R^{(J}×^{F)} is defined, and a matrix C=R^{(K}×^{F)} is defined. Then, X is decomposed into the matrix A, the matrix B, and the matrix C so as to satisfy the following Expression (1). In the following description, for convenience, an operation symbol of a Khatri-Rao product may be referred to as “⊚”.

X₍₁₎=A(C⊚B)^{T},X₍₂₎=B(C⊚A)^{T},X₍₃₎=C(A⊚B)^{T}, (1)

One type of the CPD is a method called alternating least squares (ALS). The ALS is an iterative solution. The ALS is, for example, a method of solving the following Expression (2) for updating the matrix A while fixing the matrix B and the matrix C. In the ALS, for example, calculation processing indicated in the following Expression (3) is performed.

A\hat{ }=min_{A}∥X₍₁₎−A\hat{ }(C⊚B)^{T}∥_{F}² (2)

A\hat{ }=X₍₁₎(C⊚B)(C^{T}C*B^{T}B) (3)

In Expression (3) described above, the calculation of (C^{T}C*B^{T}B) is a dense matrix product. Calculation time for the calculation of (C^{T}C*B^{T}B) is considered to be relatively short because a matrix size is relatively small. On the other hand, in Expression (3) described above, for the calculation of X₍₁₎(C⊚B), increase in calculation time and memory usage tends to be incurred because (C⊚B) is R^{(JK}×^{F)} and a matrix size tends to be relatively large. The calculation of X₍₁₎(C⊚B) is called matricized tensor times khatri-rao product (MTTKRP).

Similarly, when an expression for updating the matrix B is solved, the calculation of X₍₂₎(C⊚A) is performed, and the calculation of X₍₂₎(C⊚A) tends to incur increase in calculation time and memory usage, and is called MTTKRP. Similarly, when an expression for updating the matrix C is solved, the calculation of X₍₃₎(A⊚B) is performed, and the calculation of X₍₃₎(A⊚B) tends to incur increase in calculation time and memory usage, and is called MTTKRP. As described above, there is a problem that each MTTKRP tends to become a bottleneck of the ALS.

On the other hand, since X has sparsity, use of some elements of (C⊚B) may be dispensed with in the calculation of the MTTKRP. For example, an element of (C⊚B) multiplied by a zero element of X may not need to be used in the calculation of the MTTKRP because it is clear that a product multiplied by the zero element of X is zero.

Thus, it is considered that the calculation of the MTTKRP may be performed on the basis of a non-zero element of X and an element of (C⊚B) corresponding to the non-zero element of X without generating the whole (C⊚B) by using the sparsity. For example, the calculation of the MTTKRP may be performed by focusing on an f-th column of the matrix A, the matrix B, and the matrix C by the following Expression (4). i, j, and k are indexes of the respective dimensions of non-zero elements of X. val is a value of a non-zero element of X that corresponds to a combination of the indexes i, j, and k of the respective dimensions.

A[i][f]+=val*C[k][f]*B[j][f] (4)

Similarly, since X has sparsity, use of some elements of (C⊚A) and (A⊚B) may be dispensed with in the calculation of the MTTKRP. For example, elements of (C⊚A) and (A⊚B) multiplied by a zero element of X may not need to be used in the calculation of the MTTKRP because it is clear that a product multiplied by the zero element of X is zero.

Moreover, a case is considered where a plurality of operations in the calculation of the MTTKRP is executed in parallel to shorten calculation time. However, in this case, it is difficult to execute the plurality of operations in parallel. For example, different operations may conflict with each other and a calculation result of the MTTKRP may be incorrect. For example, when the calculation of X₍₁₎(C⊚B) is performed, different operations may conflict with each other for the same A[i][f], and values may not be properly added to A[i][f].

Furthermore, a case is considered where X is handled in a format called a compressed sparse fiber (CSF) format in an attempt to reduce calculation time and memory usage. In this case as well, the problem that different operations conflict with each other and the calculation result of the MTTKRP is incorrect may not be solved.

For example, a problem that different operations conflict with each other for any dimension and a calculation result of the MTTKRP is incorrect may not be solved. For example, it is unavoidable that different operations conflict with each other in at least any calculation of the MTTKRP among the calculation of X₍₁₎(C⊚B), the calculation of X₍₂₎(C⊚A), and the calculation of X₍₃₎(A⊚B).

As described above, conventionally, there is the problem that increase in calculation time and memory usage is incurred when the tensor data is analyzed by the CPD.

Therefore, in the present embodiment, an information processing method capable of shortening calculation time and reducing memory usage when tensor data is analyzed by the CPD will be described.

(1-1) The information processing apparatus 100 acquires first data 101. The first data 101 is data that enables, for each of non-zero elements included in multidimensional tensor data, specification of a combination of a value of the element and an index of each dimension indicating a position of the element. The first data 101 is, for example, data in a coordinated (COO) format. The COO format is a format that indicates, for each of non-zero elements, an index of each dimension of the element in association with a value of the element. The first data 101 may be, for example, data in the CSF format. The information processing apparatus 100 acquires the first data 101 by, for example, acquiring multidimensional tensor data and generating the first data 101 on the basis of the acquired multidimensional tensor data.

In the example of FIG. 1, the information processing apparatus 100 acquires the first data 101 in the COO format corresponding to the three-dimensional tensor data. It is assumed that the respective dimensions are, for example, I, J, and K. For example, for each of the non-zero elements included in the three-dimensional tensor data, the first data 101 indicates indexes i, j, and k of the respective dimensions of the element in association with a value val of the element. The index i corresponds to the dimension I. The index j corresponds to the dimension J. The index k corresponds to the dimension K. For example, the information processing apparatus 100 acquires the first data 101 by acquiring the three-dimensional tensor data and generating the first data 101 in the COO format on the basis of the acquired three-dimensional tensor data.

(1-2) The information processing apparatus 100 generates second data 102 on the basis of the acquired first data 101. The second data 102 is data that enables specification of a plurality of groups obtained by grouping each of combinations so that combinations with indexes overlapping with each other are included in different groups.

In the example of FIG. 1, for example, an index of an element of val “a” and an index of an element of val “b” overlap with each other. Thus, as indicated by a reference numeral 110, an operation on the element of val “a” and an operation on the element of val “b” may conflict with each other. Therefore, it is preferable that each of a combination related to the element of val “a” and a combination related to the element of val “b” is included in a different group. With this configuration, the information processing apparatus 100 may enable specification of an operation on each element of which two or more elements may be subjected to parallel processing without conflict.

(1-3) On the basis of the generated second data 102, the information processing apparatus 100 performs MTTKRP processing by setting each combination of a plurality of combinations included in a group as a target of parallel processing in the MTTKRP processing related to the tensor data. With this configuration, the information processing apparatus 100 may perform parallel processing on operations different from each other in the MTTKRP processing while avoiding that the different operations conflict with each other for each dimension. Thus, the information processing apparatus 100 may promote reduction in calculation time and memory usage taken for the MTTKRP processing. Furthermore, the information processing apparatus 100 may avoid that different operations conflict with each other and may accurately perform the MTTKRP processing.

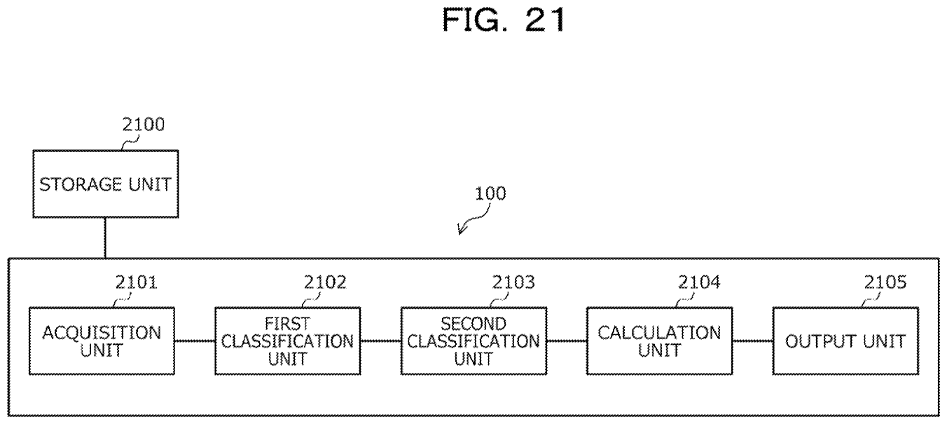

Here, a case has been described where the information processing apparatus 100 performs the MTTKRP processing on the basis of the second data 102. However, the embodiment is not limited to this. For example, there may be a case where the information processing apparatus 100 performs the MTTKRP processing on the basis of third data different from the second data 102, instead of the second data 102. The third data is data that enables specification of a plurality of groups which corresponds to a predetermined number of parallels and is obtained by grouping each of combinations so that combinations with indexes of a target dimension discontinuous with each other are not included in the same group. One example in which the information processing apparatus 100 performs the MTTKRP processing on the basis of the third data will be described later with reference to FIGS. 21 to 34, for example.

Here, a case has been described where the information processing apparatus 100 operates independently. However, the embodiment is not limited to this. For example, a case has been described where the information processing apparatus 100 acquires the first data 101 by generating the first data 101, generates the second data 102, and performs the MTTKRP processing in its own apparatus. However, the embodiment is not limited to this.

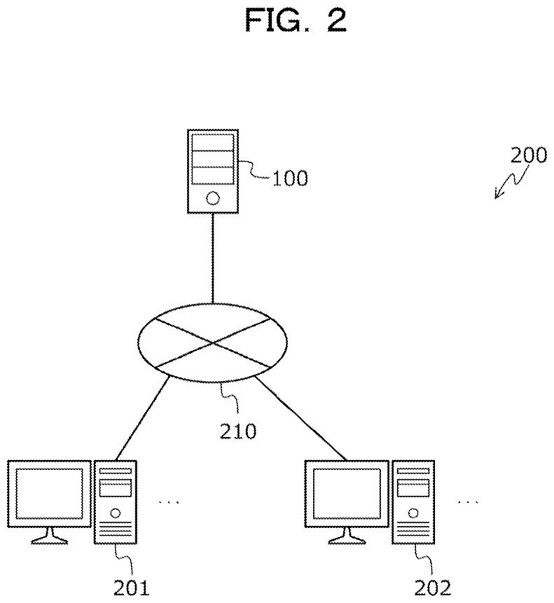

For example, there may be a case where the information processing apparatus 100 cooperates with another computer. For example, there may be a case where the information processing apparatus 100 acquires the first data 101 by receiving the first data 101 from another computer that generates the first data 101. For example, there may be a case where the information processing apparatus 100 transmits the second data 102 to another computer that performs the MTTKRP processing to perform control to cause another computer to perform the MTTKRP processing. The case where the information processing apparatus 100 cooperates with another computer will be described later with reference to FIG. 2, for example.

(One Example of CPD Calculation System 200)

Next, one example of the CPD calculation system 200 to which the information processing apparatus 100 illustrated in FIG. 1 is applied will be described with reference to FIG. 2.

FIG. 2 is an explanatory diagram illustrating one example of the CPD calculation system 200. In FIG. 2, the CPD calculation system 200 includes the information processing apparatus 100, a client device 201, and a calculation device 202.

In the CPD calculation system 200, the information processing apparatus 100 and the client device 201 are connected via a wired or wireless network 210. The network 210 is, for example, a local area network (LAN), a wide area network (WAN), or the Internet. Furthermore, the information processing apparatus 100 and the calculation device 202 are connected via the wired or wireless network 210.

The CPD calculation system 200 provides a CPD calculation service to a system user. The client device 201 is a computer used by the system user. On the basis of operation input of the system user, the client device 201 transmits, to the information processing apparatus 100, a request for performing a CPD calculation including first data in the COO format indicating multidimensional tensor data.

The client device 201 receives, from the information processing apparatus 100, a result of performing the CPD calculation for the multidimensional tensor data. The client device 201 outputs the result of performing the CPD calculation for the multidimensional tensor data so that the system user may refer to the result. The client device 201 is, for example, a server or a PC.

The information processing apparatus 100 provides the CPD calculation service. The information processing apparatus 100 is used by a system administrator of the CPD calculation system 200. The information processing apparatus 100 receives, from the client device 201, the request for performing the CPD calculation including the first data in the COO format indicating the multidimensional tensor data.

The information processing apparatus 100 converts the received first data in the COO format indicating the multidimensional tensor data into second data in a new format. The second data is data that enables specification of a plurality of groups obtained by grouping attribute information of elements. The attribute information is a combination of a value and an index of each dimension. The plurality of groups is grouped so that each of pieces of the attribute information including overlapping indexes is included in a different group. The information processing apparatus 100 transmits, to the calculation device 202, a request for performing a CPD calculation including the second data in the new format.

The information processing apparatus 100 receives, from the calculation device 202, a result of performing the CPD calculation for the multidimensional tensor data. The information processing apparatus 100 transmits, to the client device 201, the received result of performing the CPD calculation for the multidimensional tensor data. The information processing apparatus 100 is, for example, a server or a PC.

The calculation device 202 receives, from the information processing apparatus 100, the request for performing the CPD calculation including the second data in the new format. The calculation device 202 performs the CPD calculation on the basis of the second data in the new format. The calculation device 202 transmits, to the information processing apparatus 100, a result of performing the CPD calculation. The calculation device 202 is, for example, a server or a PC.

As described above, the CPD calculation system 200 may make the CPD calculation service available in the client device 201 and provide the CPD calculation service to a system user. In the following description, a case will be mainly described where the information processing apparatus 100 operates independently.

(Hardware Configuration Example of Information Processing Apparatus 100)

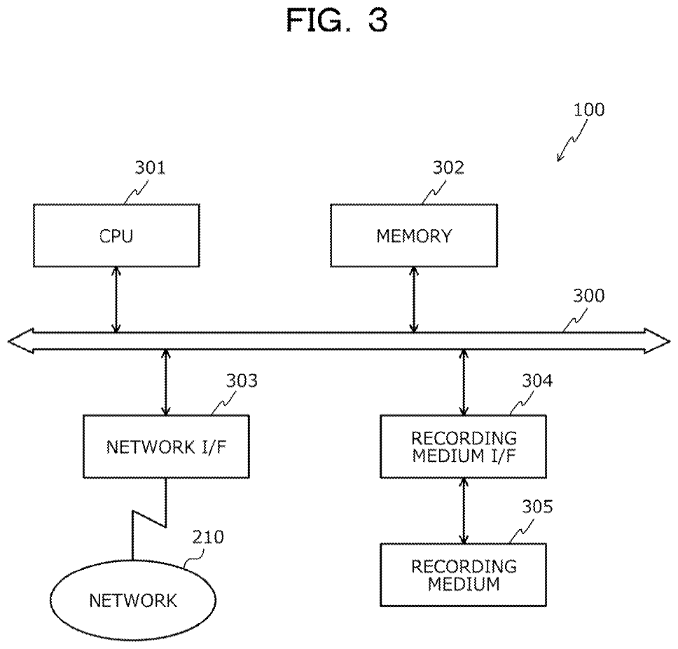

Next, a hardware configuration example of the information processing apparatus 100 will be described with reference to FIG. 3.

FIG. 3 is a block diagram illustrating the hardware configuration example of the information processing apparatus 100. In FIG. 3, the information processing apparatus 100 includes a central processing unit (CPU) 301, a memory 302, a network interface (I/F) 303, a recording medium I/F 304, and a recording medium 305. Furthermore, the respective components are connected to each other by a bus 300.

Here, the CPU 301 performs overall control of the information processing apparatus 100. The memory 302 includes, for example, a read only memory (ROM), a random access memory (RAM), and a flash ROM. For example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line and is connected to another computer via the network 210. Additionally, the network I/F 303 manages an interface between the network 210 and the inside and controls input and output of data to and from the another computer. The network I/F 303 is, for example, a modem or a LAN adapter.

The recording medium I/F 304 controls reading and writing of data from and to the recording medium 305 under the control of the CPU 301. The recording medium I/F 304 is, for example, a disk drive, a solid state drive (SSD), or a universal serial bus (USB) port. The recording medium 305 is a nonvolatile memory that stores data written under the control of the recording medium I/F 304. The recording medium 305 is, for example, a disk, a semiconductor memory, or a USB memory. The recording medium 305 may be attachable to and detachable from the information processing apparatus 100.

The information processing apparatus 100 may include, for example, a keyboard, a mouse, a display, a printer, a scanner, a microphone, or a speaker, in addition to the components described above. Furthermore, the information processing apparatus 100 may include a plurality of the recording medium I/Fs 304 and recording media 305. Furthermore, the information processing apparatus 100 does not need to include the recording medium I/F 304 or the recording medium 305.

(Hardware Configuration Example of Client Device 201)

Since a hardware configuration example of the client device 201 is similar to the hardware configuration example of the information processing apparatus 100 illustrated in FIG. 3, for example, description thereof will be omitted.

(Hardware Configuration Example of Calculation Device 202)

Since a hardware configuration example of the calculation device 202 is similar to the hardware configuration example of the information processing apparatus 100 illustrated in FIG. 3, for example, description thereof will be omitted.

(Functional Configuration Example of Information Processing Apparatus 100 According to First Operation Example)

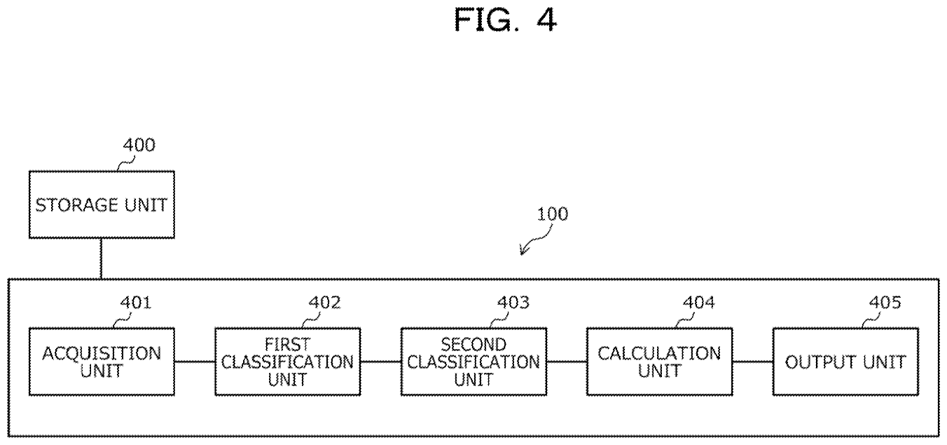

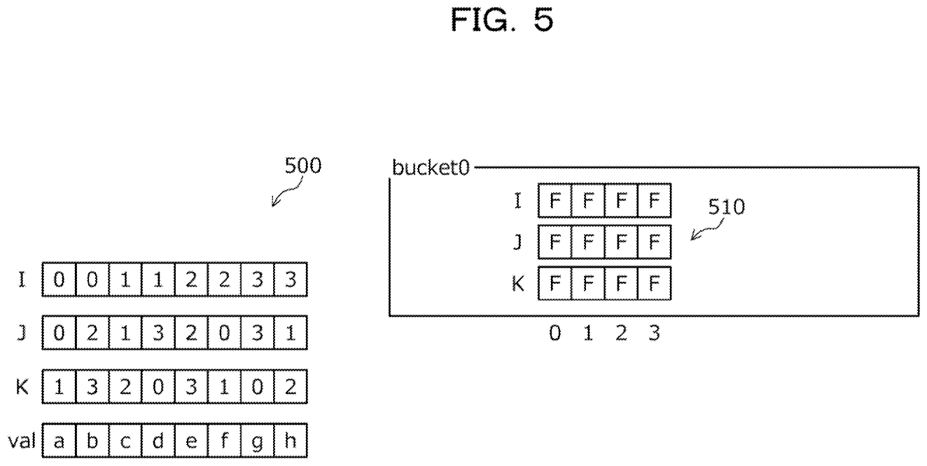

Next, a functional configuration example of the information processing apparatus 100 according to a first operation example described later with reference to FIGS. 5 to 17 will be described with reference to FIG. 4.

FIG. 4 is a block diagram illustrating the functional configuration example of the information processing apparatus 100 according to the first operation example. The information processing apparatus 100 includes a storage unit 400, an acquisition unit 401, a first classification unit 402, a second classification unit 403, a calculation unit 404, and an output unit 405.

The storage unit 400 is implemented by, for example, a storage area such as the memory 302 or the recording medium 305 illustrated in FIG. 3. Hereinafter, a case will be described where the storage unit 400 is included in the information processing apparatus 100. However, the embodiment is not limited to this. For example, there may be a case where the storage unit 400 is included in a device different from the information processing apparatus 100, and the information processing apparatus 100 is allowed to refer to stored contents of the storage unit 400.

The acquisition unit 401 to the output unit 405 function as one example of a control unit. The acquisition unit 401 to the output unit 405 implement functions thereof by, for example, causing the CPU 301 to execute a program stored in the storage area such as the memory 302 or the recording medium 305 or by the network I/F 303 illustrated in FIG. 3. A processing result of each functional unit is stored in, for example, the storage area such as the memory 302 or the recording medium 305 illustrated in FIG. 3.

The storage unit 400 stores various types of information to be referred to or updated in processing of each functional unit. The storage unit 400 stores, for example, multidimensional tensor data. The multidimensional tensor data is data including a plurality of elements. The element is associated with an index of each dimension. The multidimensional tensor data may have sparsity. The multidimensional tensor data includes, for example, a non-zero element. The multidimensional tensor data may include, for example, a zero element. The multidimensional tensor data is, for example, data that enables, for each of elements, specification of a combination of a value of the element and an index of each dimension indicating a position of the element.

The storage unit 400 stores, for example, first data. The first data is data that enables, for each of non-zero elements included in the multidimensional tensor data, specification of a combination of a value of the element and an index of each dimension indicating a position of the element. The first data is, for example, data in the COO format. The first data may be, for example, data indicating a result of determining whether or not each element included in the tensor data is non-zero. The first data may be, for example, data in which an index of each dimension of each element is associated with a flag indicating whether or not the element is non-zero. The first data is, for example, acquired by the acquisition unit 401 and stored in the storage unit 400. The first data is, for example, acquired by the first classification unit 402 and stored in the storage unit 400.

The storage unit 400 stores, for example, second data. The second data is data that enables specification of a plurality of groups obtained by grouping each of combinations so that combinations with indexes overlapping with each other are included in different groups. The second data is, for example, a multidimensional array formed by arranging, for each group, one-dimensional arrays indicating the respective combinations included in the group, and includes a pointer that specifies any one of the combinations included in the group so that the group may be divided. The second data is, for example, generated by the second classification unit 403 and stored in the storage unit 400.

The acquisition unit 401 acquires various types of information to be used for processing of each functional unit. The acquisition unit 401 stores the acquired various types of information in the storage unit 400, or outputs the acquired various types of information to each functional unit. Furthermore, the acquisition unit 401 may output the various types of information stored in the storage unit 400 to each functional unit. The acquisition unit 401 acquires the various types of information on the basis of, for example, operation input by a system administrator. The acquisition unit 401 may receive the various types of information from, for example, a device different from the information processing apparatus 100.

The acquisition unit 401 acquires tensor data. The acquisition unit 401 acquires the tensor data by, for example, receiving the tensor data from the client device 201. The acquisition unit 401 acquires the tensor data by, for example, accepting input of the tensor data on the basis of operation input by the system administrator.

The acquisition unit 401 acquires first data. The acquisition unit 401 acquires the first data by, for example, receiving the first data from the client device 201. The acquisition unit 401 acquires the first data by, for example, accepting input of the first data on the basis of operation input by the system administrator. In the case of acquiring the first data, the acquisition unit 401 does not have to acquire the tensor data.

The acquisition unit 401 may accept a start trigger to start processing of any one of the functional units. The start trigger is, for example, predetermined operation input made by the system administrator. The start trigger may be, for example, receipt of predetermined information from another computer. The start trigger may be, for example, output of predetermined information by any one of the functional units.

The acquisition unit 401 accepts, for example, acquisition of the tensor data as a start trigger to start processing of the first classification unit 402, the second classification unit 403, and the calculation unit 404. The acquisition unit 401 accepts, for example, acquisition of the first data as a start trigger to start processing of the second classification unit 403 and the calculation unit 404.

The first classification unit 402 acquires first data. The first classification unit 402 acquires the first data by, for example, generating the first data on the basis of tensor data. For example, the first classification unit 402 determines whether or not each of elements included in the tensor data is non-zero. The first classification unit 402 acquires the first data by generating the first data that enables, for each of elements determined to be non-zero, specification of a combination of a value of the element and an index of each dimension indicating a position of the element. With this configuration, the first classification unit 402 may enable specification of which element is non-zero and is to be used for the MTTKRP processing.

For example, the first classification unit 402 may determine whether or not each of the elements included in the tensor data is non-zero, and acquire the first data indicating a result of determining whether or not each of the elements included in the tensor data is non-zero. For example, the first classification unit 402 may acquire data indicating a result of determining, for each of the elements included in the tensor data, whether or not the element is non-zero. With this configuration, the first classification unit 402 may enable specification of which element is non-zero and is to be used for the MTTKRP processing.

The second classification unit 403 generates second data on the basis of acquired first data. The second classification unit 403 groups each of combinations so that, for example, combinations with indexes overlapping with each other are included in different groups. The second classification unit 403 generates, for example, the second data that enables specification of a plurality of groups obtained by grouping. With this configuration, the second classification unit 403 may enable specification of a group of combinations that may be subjected to parallel processing, and may enable efficient performance of the MTTKRP processing. The second classification unit 403 may promote reduction in memory usage related to the MTTKRP processing.

The calculation unit 404 performs, on the basis of generated second data, the MTTKRP processing by setting each combination of a plurality of combinations included in a group as a target of parallel processing in the MTTKRP processing related to the tensor data. The calculation unit 404 performs the MTTKRP processing by setting for example, all combinations included in the group as targets of the parallel processing.

The calculation unit 404 performs the MTTKRP processing by setting, for example, a predetermined number of combinations included in the group as targets of the parallel processing. With this configuration, the calculation unit 404 may efficiently perform the MTTKRP processing. The calculation unit 404 may promote reduction in calculation time. The calculation unit 404 may avoid a calculation error in the MTTKRP processing. The calculation unit 404 may further perform ALS processing on the basis of a result of performing the MTTKRP processing. With this configuration, the calculation unit 404 may analyze the tensor data.

The output unit 405 outputs a processing result of at least any one of the functional units. An output format is, for example, display on a display, print output to a printer, transmission to an external device by the network I/F 303, or storage in the storage area such as the memory 302 or the recording medium 305. With this configuration, the output unit 405 enables notification of a processing result of at least any one of the functional units to the system administrator and may promote improvement in convenience of the information processing apparatus 100.

The output unit 405 outputs, for example, a result of performing the MTTKRP processing. With this configuration, the output unit 405 may facilitate performance of the ALS. The output unit 405 outputs, for example, a result of performing the ALS processing. With this configuration, the output unit 405 may enable a system user to refer to the result of performing the ALS processing, and may facilitate analysis of the tensor data.

Here, a case has been described where the information processing apparatus 100 includes the first classification unit 402, the second classification unit 403, and the calculation unit 404. However, the embodiment is not limited to this. For example, there may be a case where the information processing apparatus 100 does not include the calculation unit 404 and may be able to communicate with another computer including the calculation unit 404. For example, in a case where the acquisition unit 401 acquires the first data, the information processing apparatus 100 does not have to include the first classification unit 402.

(First Operation Example of Information Processing Apparatus 100)

Next, the first operation example of the information processing apparatus 100 will be described with reference to FIGS. 5 to 17.

FIGS. 5 to 17 are explanatory diagrams illustrating the first operation example of the information processing apparatus 100. In FIG. 5, the information processing apparatus 100 acquires first data 500 in the COO format corresponding to three-dimensional tensor data. It is assumed that the respective dimensions are I, J, and K. The first data 500 enables specification of attribute information of each of non-zero elements included in the three-dimensional tensor data.

The attribute information includes a value val of an element and indexes i, j, and k of the respective dimensions indicating a position of the element. The first data 500 indicates attribute information of a non-zero element in each column. In the following description, attribute information including a value val of an element and indexes i, j, and k of the respective dimensions indicating a position of the element may be referred to as “attribute information (i, j, k, and val)”.

The information processing apparatus 100 prepares a bucket 0. The bucket 0 may store attribute information (i, j, k, and val) of a non-zero element included in the first data 500. The bucket 0 is a storage area for collecting attribute information (i, j, k, and val) of each of the non-zero elements, which is included in the first data 500 and does not have indexes overlapping with each other.

The bucket 0 includes an array group 510. The array group 510 includes an array [ ] corresponding to the respective dimensions. The array [ ] corresponding to the respective dimensions has a size of the maximum value+1 of indexes of the dimensions. In the example of FIG. 5, since index values of the respective dimensions are 0 to 3, the size of the array [ ] corresponding to the respective dimensions is 4.

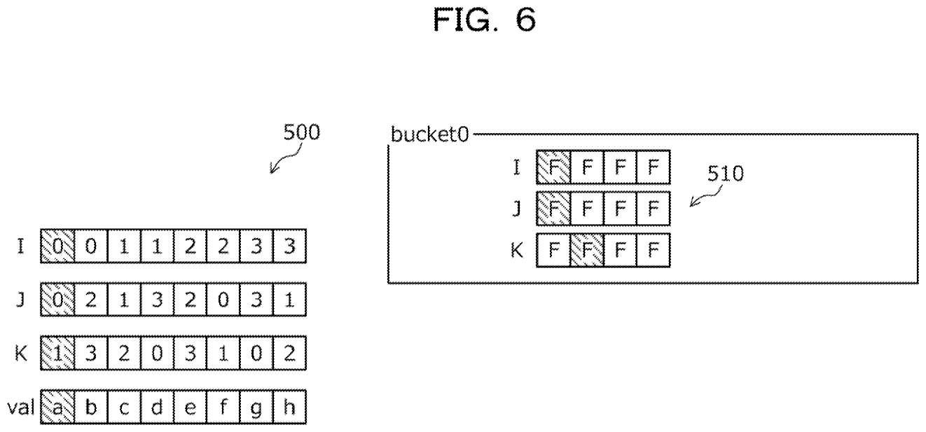

Elements of the array [ ] corresponding to the respective dimensions correspond to the index values 0, 1, 2, and 3 of the dimensions in order from the beginning. The value of each of the elements of the array [ ] corresponding to the respective dimensions is a flag indicating whether or not the attribute information (i, j, k, and val) of the non-zero element included in the first data 500 corresponding to the index value corresponding to the element has been stored in the bucket 0. When the flag is True (T), it is indicated that the attribute information (i, j, k, and val) has been stored. When the flag is False (F), it is indicated that the attribute information (i, j, k, and val) has not been stored. The value of each of the elements of the array [ ] corresponding to the respective dimensions is initialized to F. Next, description of FIG. 6 will be made.

In FIG. 6, the information processing apparatus 100 extracts attribute information (0, 0, 1, and a) of a non-zero element from a first column of the first data 500. The information processing apparatus 100 determines whether or not the values of the elements of the array [ ] corresponding to the index values of the respective dimensions included in the extracted attribute information (0, 0, 1, and a) of the non-zero element in the array group 510 are False.

Here, when one or more of the values of the elements of the array [ ] corresponding to the index values of the respective dimensions are True, it is considered that the extracted attribute information of the non-zero element has the indexes overlapping with those of another piece of attribute information that has been stored in the bucket 0. On the other hand, when all the values of the elements of the array [ ] corresponding to the index values of the respective dimensions are False, it is considered that the extracted attribute information of the non-zero element has the indexes not overlapping with those of another piece of attribute information even when there is the another piece of attribute information that has been stored in the bucket 0. Therefore, it is considered that the extracted attribute information of the non-zero element may be stored in the bucket 0.

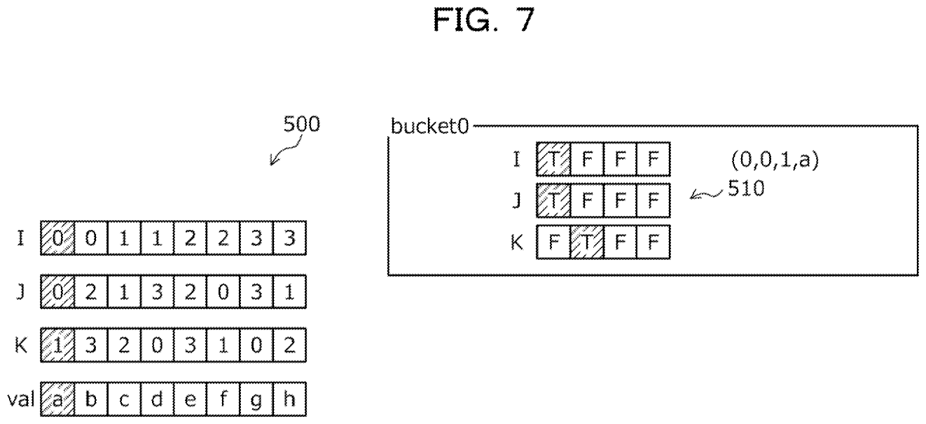

In the example of FIG. 6, the information processing apparatus 100 determines that all the values of the elements of the array [ ] corresponding to the index values (0, 0, and 1) of the respective dimensions in the array group 510 are False. Therefore, the information processing apparatus 100 determines that the extracted attribute information (0, 0, 1, and a) of the non-zero element may be stored in the bucket 0. Next, description of FIG. 7 will be made.

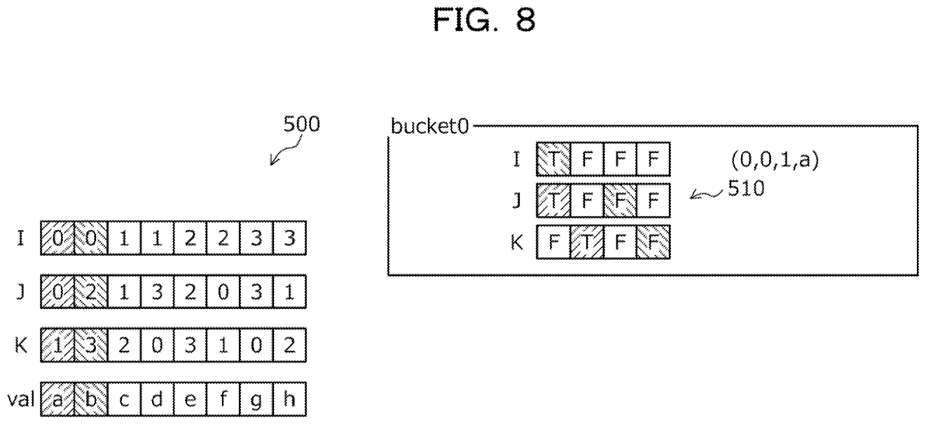

In FIG. 7, since the information processing apparatus 100 has determined that the extracted attribute information (0, 0, 1, and a) of the non-zero element may be stored in the bucket 0, the information processing apparatus 100 stores the extracted attribute information (0, 0, 1, and a) of the non-zero element in the bucket 0. The information processing apparatus 100 sets all the values of the elements of the array [ ] corresponding to the index values (0, 0, and 1) of the respective dimensions in the array group 510 to True. With this configuration, the information processing apparatus 100 may prevent another piece of attribute information having indexes overlapping with those of the stored attribute information (0, 0, 1, and a) of the non-zero element from being stored in the bucket 0. Next, description of FIG. 8 will be made.

In FIG. 8, the information processing apparatus 100 extracts attribute information (0, 2, 3, and b) of a non-zero element from a second column of the first data 500. The information processing apparatus 100 determines whether or not the values of the elements of the array [ ] corresponding to the index values of the respective dimensions included in the extracted attribute information (0, 2, 3, and b) of the non-zero element in the array group 510 are False.

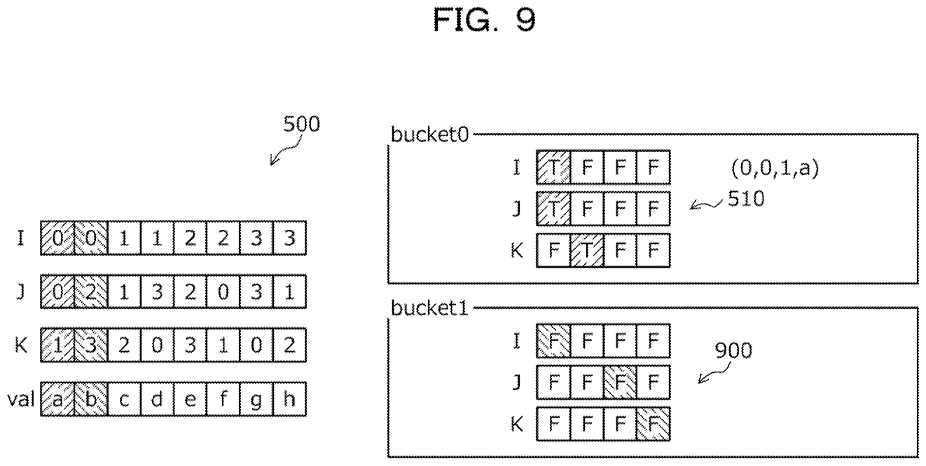

In the example of FIG. 8, the information processing apparatus 100 determines that the value of the element of the array [0] corresponding to the index value i=0 of the dimension I in the array group 510 is True. Therefore, the information processing apparatus 100 determines that it is not preferable to store the extracted attribute information (0, 2, 3, and b) of the non-zero element in the bucket 0. Next, description of FIG. 9 will be made.

In FIG. 9, the information processing apparatus 100 prepares a bucket 1. The bucket 1 may store the attribute information (i, j, k, and val) of the non-zero element included in the first data 500. The bucket 1 is a storage area for collecting the attribute information (i, j, k, and val) of each of the non-zero elements, which is included in the first data 500 and does not have indexes overlapping with each other.

The bucket 1 includes an array group 900. The array group 900 is similar to the array group 510. The array group 900 includes an array [ ] corresponding to the respective dimensions. The array [ ] corresponding to the respective dimensions has a size of the maximum value+1 of indexes of the dimensions. In the example of FIG. 9, since index values of the respective dimensions are 0 to 3, the size of the array [ ] corresponding to the respective dimensions is 4.

Elements of the array [ ] corresponding to the respective dimensions correspond to the index values 0, 1, 2, and 3 of the dimensions in order from the beginning. The value of each of the elements of the array [ ] corresponding to the respective dimensions is a flag indicating whether or not the attribute information (i, j, k, and val) of the non-zero element included in the first data 500 corresponding to the index value corresponding to the element has been stored in the bucket 1. The value of each of the elements of the array [ ] corresponding to the respective dimensions is initialized to F.

The information processing apparatus 100 determines whether or not the values of the elements of the array [ ] corresponding to the index values of the respective dimensions included in the extracted attribute information (0, 2, 3, and b) of the non-zero element in the array group 900 are False.

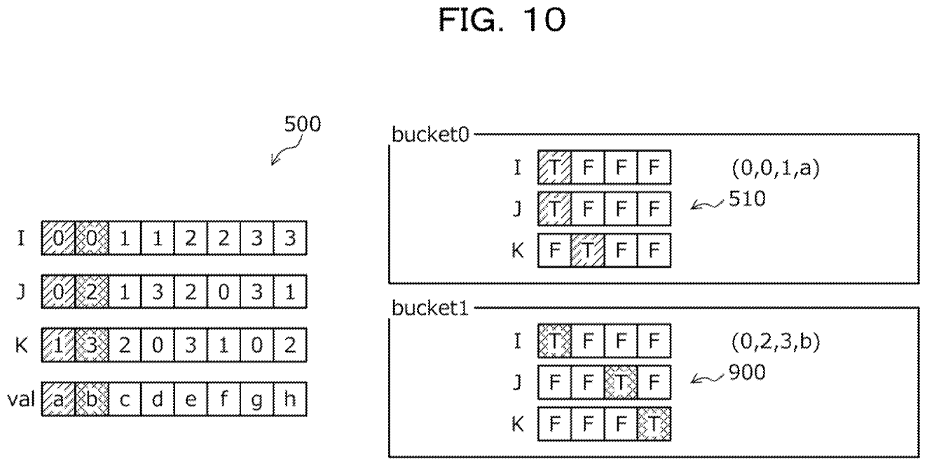

In the example of FIG. 9, the information processing apparatus 100 determines that all the values of the elements of the array [ ] corresponding to the index values (0, 2, and 3) of the respective dimensions in the array group 900 are False. Therefore, the information processing apparatus 100 determines that the extracted attribute information (0, 2, 3, and b) of the non-zero element may be stored in the bucket 1. Next, description of FIG. 10 will be made.

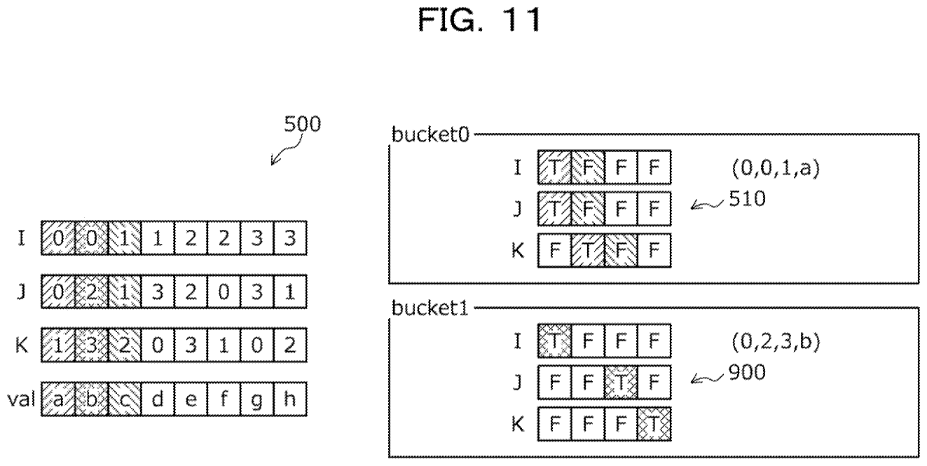

In FIG. 10, since the information processing apparatus 100 has determined that the extracted attribute information (0, 2, 3, and b) of the non-zero element may be stored in the bucket 1, the information processing apparatus 100 stores the extracted attribute information (0, 2, 3, and b) of the non-zero element in the bucket 1. The information processing apparatus 100 sets all the values of the elements of the array [ ] corresponding to the index values (0, 2, and 3) of the respective dimensions in the array group 900 to True. With this configuration, the information processing apparatus 100 may prevent another piece of attribute information having indexes overlapping with those of the stored attribute information (0, 2, 3, and b) of the non-zero element from being stored in the bucket 1. Next, description of FIG. 11 will be made.

In FIG. 11, the information processing apparatus 100 extracts attribute information (1, 1, 2, and c) of a non-zero element from a third column of the first data 500. The information processing apparatus 100 determines whether or not the values of the elements of the array [ ] corresponding to the index values of the respective dimensions included in the extracted attribute information (1, 1, 2, and c) of the non-zero element in the array group 510 are False.

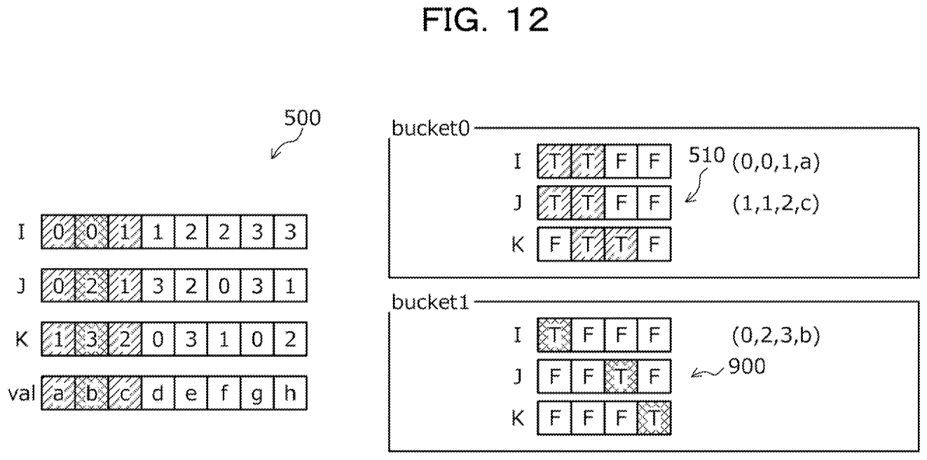

In the example of FIG. 11, the information processing apparatus 100 determines that all the values of the elements of the array [ ] corresponding to the index values (1, 1, and 2) of the respective dimensions in the array group 510 are False. Therefore, the information processing apparatus 100 determines that the extracted attribute information (1, 1, 2, and c) of the non-zero element may be stored in the bucket 0. Next, description of FIG. 12 will be made.

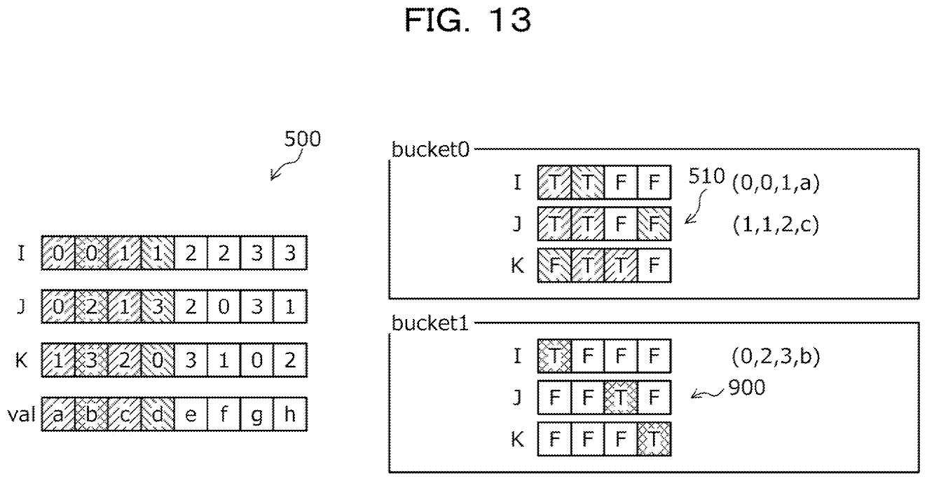

In FIG. 12, since the information processing apparatus 100 has determined that the extracted attribute information (1, 1, 2, and c) of the non-zero element may be stored in the bucket 0, the information processing apparatus 100 stores the extracted attribute information (1, 1, 2, and c) of the non-zero element in the bucket 0. The information processing apparatus 100 sets all the values of the elements of the array [ ] corresponding to the index values (1, 1, and 2) of the respective dimensions in the array group 510 to True. With this configuration, the information processing apparatus 100 may prevent another piece of attribute information having indexes overlapping with those of the stored attribute information (1, 1, 2, and c) of the non-zero element from being stored in the bucket 0. Next, description of FIG. 13 will be made.

In FIG. 13, the information processing apparatus 100 extracts attribute information (1, 3, 0, and d) of a non-zero element from a fourth column of the first data 500. The information processing apparatus 100 determines whether or not the values of the elements of the array [ ] corresponding to the index values of the respective dimensions included in the extracted attribute information (1, 3, 0, and d) of the non-zero element in the array group 510 are False.

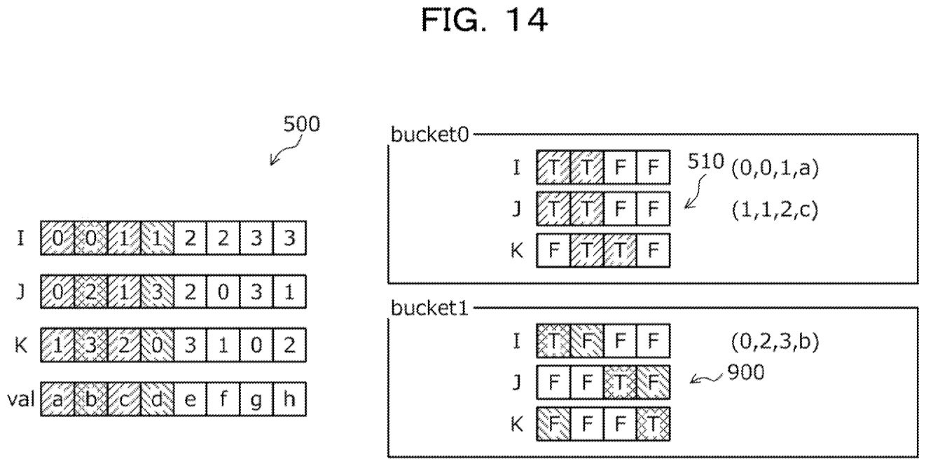

In the example of FIG. 13, the information processing apparatus 100 determines that the value of the element of the array [1] corresponding to the index value i=1 of the dimension I in the array group 510 is True. Therefore, the information processing apparatus 100 determines that it is not preferable to store the extracted attribute information (1, 3, 0, and d) of the non-zero element in the bucket 0. Next, description of FIG. 14 will be made.

In FIG. 14, it is determined whether or not the values of the elements of the array [ ] corresponding to the index values of the respective dimensions included in the extracted attribute information (1, 3, 0, and d) of the non-zero element in the array group 900 are False.

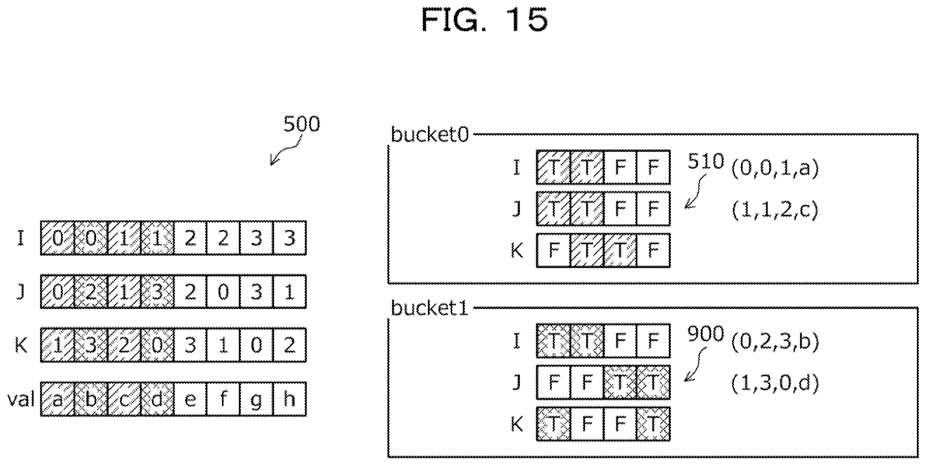

In the example of FIG. 14, the information processing apparatus 100 determines that all the values of the elements of the array [ ] corresponding to index values (1, 3, and 0) of the respective dimensions in the array group 900 are False. Therefore, the information processing apparatus 100 determines that the extracted attribute information (1, 3, 0, and d) of the non-zero element may be stored in the bucket 1. Next, description of FIG. 15 will be made.

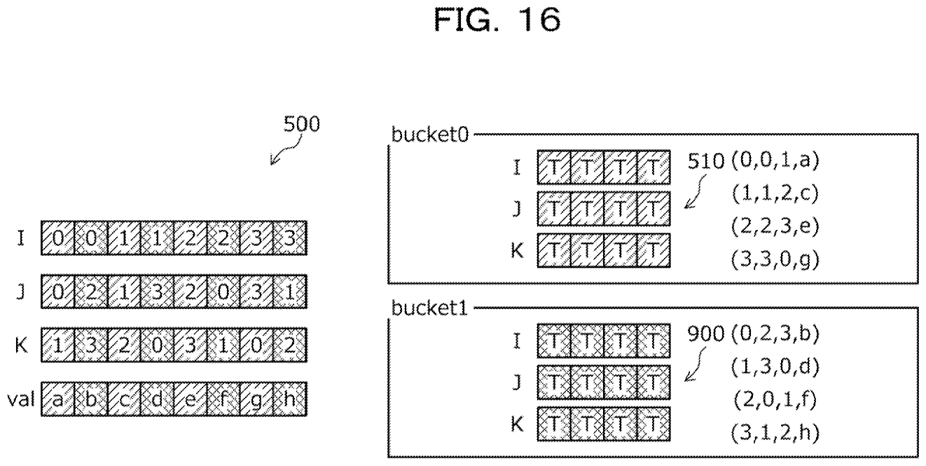

In FIG. 15, since the information processing apparatus 100 has determined that the extracted attribute information (1, 3, 0, and d) of the non-zero element may be stored in the bucket 1, the information processing apparatus 100 stores the extracted attribute information (1, 3, 0, and d) of the non-zero element in the bucket 1. The information processing apparatus 100 sets all the values of the elements of the array [ ] corresponding to the index values (1, 3, and 0) of the respective dimensions in the array group 900 to True. With this configuration, the information processing apparatus 100 may prevent another piece of attribute information having indexes overlapping with those of the stored attribute information (1, 3, 0, and d) of the non-zero element from being stored in the bucket 1. Next, description of FIG. 16 will be made.

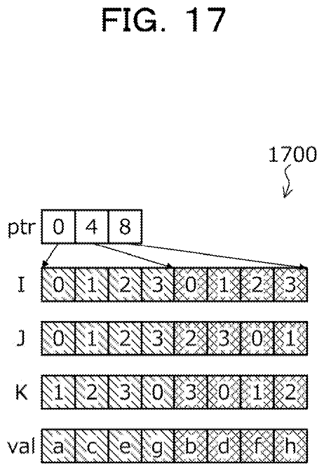

In FIG. 16, similarly, the information processing apparatus 100 extracts attribute information of a non-zero element in order from a fifth column and subsequent columns of the first data 500, and determines whether or not the extracted attribute information of the non-zero element may be stored in each bucket. The information processing apparatus 100 stores the extracted attribute information of the non-zero element in a bucket determined to be capable of storing the attribute information. As a result, the information processing apparatus 100 stores attribute information (2, 2, 3, and e), attribute information (3, 3, 0, and g), and the like in the bucket 0. Furthermore, the information processing apparatus 100 stores attribute information (2, 0, 1, and f), attribute information (3, 1, 2, and h), and the like in the bucket 1. Next, description of FIG. 17 will be made.

In FIG. 17, the information processing apparatus 100 arranges the attribute information stored in each bucket in order, and generates a pointer array ptr[ ] that specifies the attribute information so that a group of the attribute information stored in each bucket may be divided.

In the example of FIG. 17, the information processing apparatus 100 prepares a storage destination area 1700. The information processing apparatus 100 sets, in a pointer array ptr[0], a pointer indicating a storage destination that stores the attribute information included in the bucket 0, and a start position 0 of the storage destination area 1700. The information processing apparatus 100 stores each piece of the attribute information stored in the bucket 0 in order from the position 0 specified by the pointer array ptr[0] in the storage destination area 1700.

The information processing apparatus 100 sets, in a pointer array ptr[1], a pointer indicating a storage destination that stores the attribute information included in the bucket 1, and a position 4 next to the position where the attribute information included in the bucket 0 has been stored. The information processing apparatus 100 stores each piece of the attribute information stored in the bucket 1 in order from the position 4 specified by the pointer array ptr[1] in the storage destination area 1700.

The information processing apparatus 100 sets, in a pointer array ptr[2], a pointer indicating a position 8 next to the position where the attribute information included in the bucket 1 has been stored. The information processing apparatus 100 outputs the data formed in the storage destination area 1700 as the second data used for the MTTKRP processing. With this configuration, the information processing apparatus 100 may enable specification of a group obtained by collecting non-zero elements, which may be subjected to parallel processing in the MTTKRP processing. Thus, the information processing apparatus 100 may promote reduction in the calculation time taken for the MTTKRP processing.

For example, in the ALS, the information processing apparatus 100 may promote reduction in the calculation time and the memory usage taken for the MTTKRP processing such as the calculation of X₍₁₎(C⊚B), the calculation of X₍₂₎(C⊚A), and the calculation of X₍₃₎(A⊚B). Therefore, the information processing apparatus 100 may facilitate elimination of the bottleneck of the ALS, and may promote reduction in the calculation time taken for analyzing the tensor data by the ALS.

Furthermore, for example, the information processing apparatus 100 may avoid that different operations conflict with each other in the MTTKRP processing, and may accurately perform the MTTKRP processing. Furthermore, the information processing apparatus 100 may format the second data in a similar manner to the format of the first data 500, and may suppress deterioration in convenience of the second data.

Here, a case has been described where the information processing apparatus 100 acquires the first data 500 in the COO format. However, the embodiment is not limited to this. For example, there may be a case where the information processing apparatus 100 acquires data in the CSF format instead of the first data 500 in the COO format, and generates the second data used for the MTTKRP processing on the basis of the data in the CSF format.

(First Classification Processing Procedure in First Operation Example)

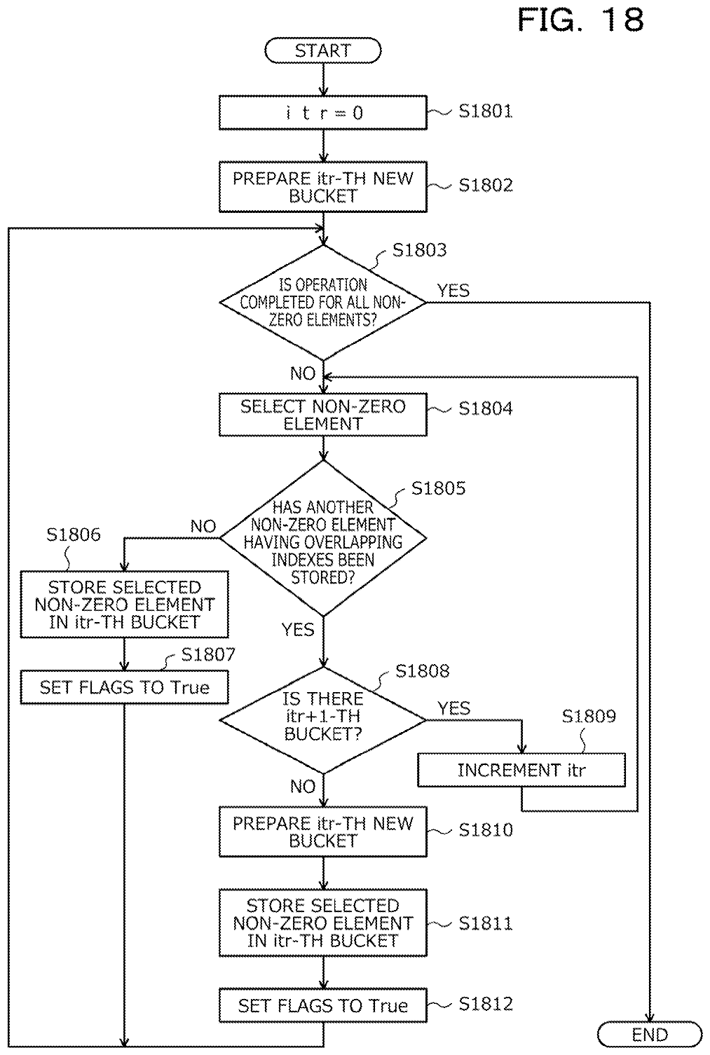

Next, one example of a first classification processing procedure in the first operation example executed by the information processing apparatus 100 will be described with reference to FIG. 18. First classification processing is implemented by, for example, the CPU 301, the storage area such as the memory 302 or the recording medium 305, and the network I/F 303 illustrated in FIG. 3.

FIG. 18 is a flowchart illustrating one example of the first classification processing procedure in the first operation example. In FIG. 18, the information processing apparatus 100 sets itr=0 (Step S1801).

Next, the information processing apparatus 100 prepares an itr-th new bucket (Step S1802). Then, the information processing apparatus 100 determines whether or not operation is completed for all non-zero elements in tensor data (Step S1803).

Here, in a case where operation is completed for all the non-zero elements (Step S1803: Yes), the information processing apparatus 100 terminates the first classification processing. On the other hand, in a case where operation is not completed for any one of the non-zero elements (Step S1803: No), the information processing apparatus 100 proceeds to processing of Step S1804.

In Step S1804, the information processing apparatus 100 selects a non-zero element that has not yet been selected from the tensor data as an operation target (Step S1804). Next, on the basis of flags of indexes, the information processing apparatus 100 determines whether or not another non-zero element having indexes overlapping with those of the selected non-zero element as the operation target has been stored in the itr-th bucket (Step S1805).

Here, in a case where the another non-zero element has been stored (Step S1805: Yes), the information processing apparatus 100 proceeds to processing of Step S1808. On the other hand, in a case where the another non-zero element has not been stored (Step S1805: No), the information processing apparatus 100 proceeds to processing of Step S1806.

In Step S1806, the information processing apparatus 100 stores the selected non-zero element as the operation target in the itr-th bucket (Step S1806). Next, the information processing apparatus 100 sets the flags of the indexes of the stored non-zero element to True (Step S1807). Then, the information processing apparatus 100 returns to the processing of Step S1803.

In Step S1808, the information processing apparatus 100 determines whether or not there is an itr+1-th bucket (Step S1808). Here, in a case where there is the itr+1-th bucket (Step S1808: Yes), the information processing apparatus 100 proceeds to processing of Step S1809. On the other hand, in a case where there is not the itr+1-th bucket (Step S1808: No), the information processing apparatus 100 proceeds to processing of Step S1810.

In Step S1809, the information processing apparatus 100 increments itr (Step S1809). Then, the information processing apparatus 100 returns to the processing of Step S1804.

In Step S1810, the information processing apparatus 100 prepares an itr-th new bucket (Step S1810). Next, the information processing apparatus 100 stores a selected non-zero element as an operation target in the prepared itr-th bucket (Step S1811).

Then, the information processing apparatus 100 sets flags of indexes of the stored non-zero element to True (Step S1812). Thereafter, the information processing apparatus 100 returns to the processing of Step S1803.

(Second Classification Processing Procedure in First Operation Example)

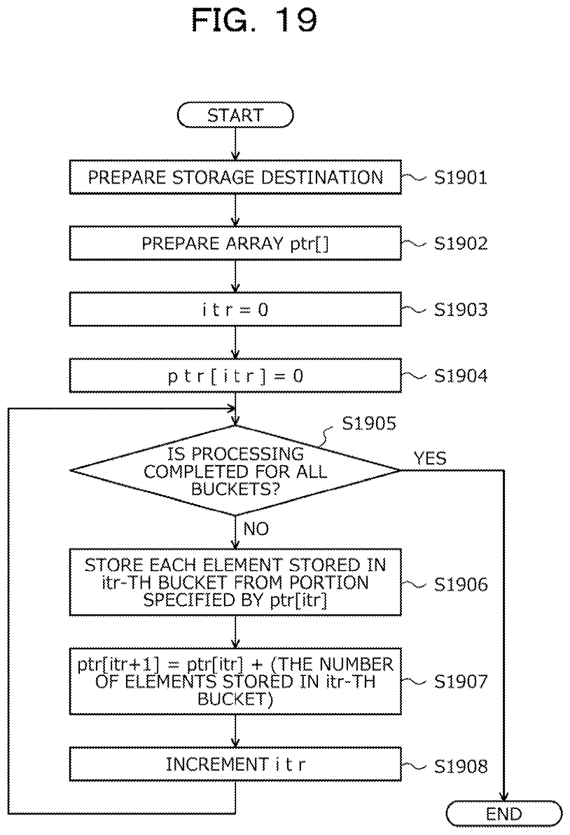

Next, one example of a second classification processing procedure in the first operation example executed by the information processing apparatus 100 will be described with reference to FIG. 19. Second classification processing is implemented by, for example, the CPU 301, the storage area such as the memory 302 or the recording medium 305, and the network I/F 303 illustrated in FIG. 3.

FIG. 19 is a flowchart illustrating one example of the second classification processing procedure in the first operation example. In FIG. 19, the information processing apparatus 100 prepares a storage destination (Step S1901).

Next, the information processing apparatus 100 prepares an array ptr[ ] (Step S1902). Then, the information processing apparatus 100 sets itr=0 (Step S1903).

Next, the information processing apparatus 100 sets ptr[itr]=0 (Step S1904). Then, the information processing apparatus 100 determines whether or not processing is completed for all buckets (Step S1905).

Here, in a case where the processing is completed for all the buckets (Step S1905: Yes), the information processing apparatus 100 terminates the second classification processing. On the other hand, in a case where the processing is not completed for any one of the buckets (Step S1905: No), the information processing apparatus 100 proceeds to processing of Step S1906.

In Step S1906, the information processing apparatus 100 stores each element stored in an itr-th bucket in order from a portion specified by ptr[itr] in the storage destination (Step S1906). Next, the information processing apparatus 100 sets ptr[itr+1]=ptr[itr]+(the number of elements stored in the itr-th bucket) (Step S1907).

Then, the information processing apparatus 100 increments itr (Step S1908). Thereafter, the information processing apparatus 100 returns to the processing of Step S1905.

(Calculation Processing Procedure in First Operation Example)

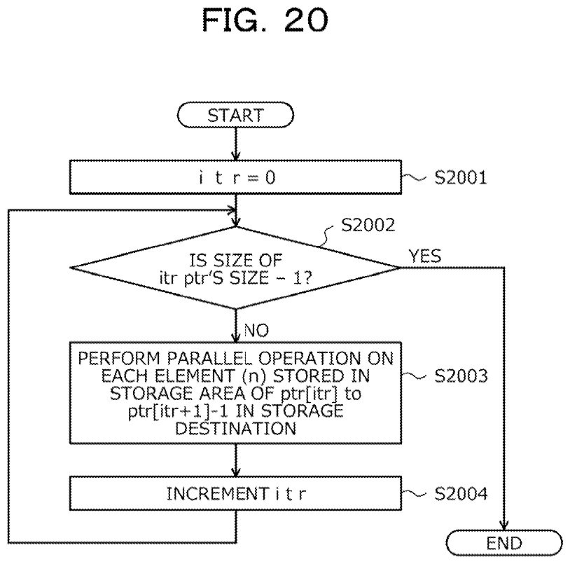

Next, one example of a calculation processing procedure in the first operation example executed by the information processing apparatus 100 will be described with reference to FIG. 20. Calculation processing in the first operation example is implemented by, for example, the CPU 301, the storage area such as the memory 302 or the recording medium 305, and the network I/F 303 illustrated in FIG. 3.

FIG. 20 is a flowchart illustrating one example of the calculation processing procedure in the first operation example. In FIG. 20, the information processing apparatus 100 sets itr=0 (Step S2001).

Next, the information processing apparatus 100 determines whether or not a size of itr is a ptr's size−1 (Step S2002). Here, in a case where the size of itr is the ptr's size−1 (Step S2002: Yes), the information processing apparatus 100 terminates the calculation processing. On the other hand, in a case where the size of itr is not the ptr's size−1 (Step S2002: No), the information processing apparatus 100 proceeds to processing of Step S2003.

In Step S2003, the information processing apparatus 100 performs parallel operation on each element (n) stored in a storage area of ptr[itr] to ptr[itr+1]−1 in a storage destination (Step S2003). The parallel operation is defined by, for example, the following Expression (5).

for f in F:A[I[n],f]+=val[n]*C[K[n],f]*B[J[n],f] (5)

Next, the information processing apparatus 100 increments itr (Step S2004). Then, the information processing apparatus 100 returns to the processing of Step S2002. With this configuration, the information processing apparatus 100 may perform the MTTKRP processing.

(Functional Configuration Example of Information Processing Apparatus 100 According to Second Operation Example)

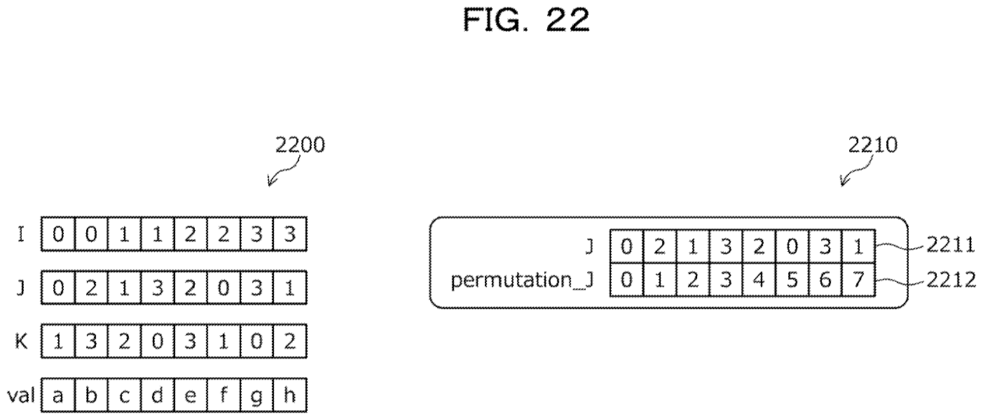

Next, a functional configuration example of the information processing apparatus 100 according to a second operation example described later with reference to FIGS. 22 to 30 will be described with reference to FIG. 21.

FIG. 21 is a block diagram illustrating the functional configuration example of the information processing apparatus 100 according to the second operation example. The information processing apparatus 100 includes a storage unit 2100, an acquisition unit 2101, a first classification unit 2102, a second classification unit 2103, a calculation unit 2104, and an output unit 2105.

The storage unit 2100 is implemented by, for example, the storage area such as the memory 302 or the recording medium 305 illustrated in FIG. 3. Hereinafter, a case will be described where the storage unit 2100 is included in the information processing apparatus 100. However, the embodiment is not limited to this. For example, there may be a case where the storage unit 2100 is included in a device different from the information processing apparatus 100, and the information processing apparatus 100 is allowed to refer to stored contents of the storage unit 2100.

The acquisition unit 2101 to the output unit 2105 function as one example of a control unit. The acquisition unit 2101 to the output unit 2105 implement functions thereof by, for example, causing the CPU 301 to execute a program stored in the storage area such as the memory 302 or the recording medium 305 or by the network I/F 303 illustrated in FIG. 3. A processing result of each functional unit is stored in, for example, the storage area such as the memory 302 or the recording medium 305 illustrated in FIG. 3.

The storage unit 2100 stores various types of information to be referred to or updated in processing of each functional unit. The storage unit 2100 stores, for example, multidimensional tensor data. The multidimensional tensor data is data including a plurality of elements. The element is associated with an index of each dimension. The multidimensional tensor data may have sparsity. The multidimensional tensor data includes, for example, a non-zero element. The multidimensional tensor data may include, for example, a zero element. The multidimensional tensor data is, for example, data that enables, for each of elements, specification of a combination of a value of the element and an index of each dimension indicating a position of the element.

The storage unit 2100 stores, for example, first data. The first data is data that enables, for each of non-zero elements included in the multidimensional tensor data, specification of a combination of a value of the element and an index of each dimension indicating a position of the element. The first data is, for example, data in the COO format. The first data is, for example, data in a structure of array (SoA) format. The first data may be, for example, data indicating a result of determining whether or not each element included in the tensor data is non-zero. The first data may be, for example, data in which an index of each dimension of each element is associated with a flag indicating whether or not the element is non-zero. The first data is, for example, acquired by the acquisition unit 2101 and stored in the storage unit 2100. The first data is, for example, acquired by the first classification unit 2102 and stored in the storage unit 2100.

The storage unit 2100 stores, for example, third data. The third data is data that enables specification of a plurality of groups which corresponds to a predetermined number of parallels. The plurality of groups is obtained by grouping each of combinations so that combinations with indexes of a target dimension discontinuous with each other are not included in the same group according to predetermined order with respect to the indexes of the target dimension. The third data includes, for example, a pointer for each group that specifies any one of combinations included in the group. The third data is, for example, generated by the second classification unit 2103 and stored in the storage unit 2100.

The acquisition unit 2101 acquires various types of information to be used for processing of each functional unit. The acquisition unit 2101 stores the acquired various types of information in the storage unit 2100, or outputs the acquired various types of information to each functional unit. Furthermore, the acquisition unit 2101 may output the various types of information stored in the storage unit 2100 to each functional unit. The acquisition unit 2101 acquires the various types of information on the basis of, for example, operation input by the system administrator. The acquisition unit 2101 may receive the various types of information from, for example, a device different from the information processing apparatus 100.

The acquisition unit 2101 acquires tensor data. The acquisition unit 2101 acquires the tensor data by, for example, receiving the tensor data from the client device 201. The acquisition unit 2101 acquires the tensor data by, for example, accepting input of the tensor data on the basis of operation input by the system administrator.

The acquisition unit 2101 acquires first data. The acquisition unit 2101 acquires the first data by, for example, receiving the first data from the client device 201. The acquisition unit 2101 acquires the first data by, for example, accepting input of the first data on the basis of operation input by the system administrator. In the case of acquiring the first data, the acquisition unit 2101 does not have to acquire the tensor data.

The acquisition unit 2101 may accept a start trigger to start processing of any one of the functional units. The start trigger is, for example, predetermined operation input made by the system administrator. The start trigger may be, for example, receipt of predetermined information from another computer. The start trigger may be, for example, output of predetermined information by any one of the functional units.

The acquisition unit 2101 accepts, for example, acquisition of the tensor data as a start trigger to start processing of the first classification unit 2102, the second classification unit 2103, and the calculation unit 2104. The acquisition unit 2101 accepts, for example, acquisition of the first data as a start trigger to start processing of the second classification unit 2103 and the calculation unit 2104.

The first classification unit 2102 acquires first data. The first classification unit 2102 acquires the first data by, for example, generating the first data on the basis of tensor data. For example, the first classification unit 2102 determines whether or not each of elements included in the tensor data is non-zero. The first classification unit 2102 acquires the first data by generating the first data that enables, for each of elements determined to be non-zero, specification of a combination of a value of the element and an index of each dimension indicating a position of the element. With this configuration, the first classification unit 2102 may enable specification of which element is non-zero and is to be used for the MTTKRP processing.

For example, the first classification unit 2102 may determine whether or not each of the elements included in the tensor data is non-zero, and acquire the first data indicating a result of determining whether or not each of the elements included in the tensor data is non-zero. For example, the first classification unit 2102 may acquire data indicating a result of determining, for each of the elements included in the tensor data, whether or not the element is non-zero. With this configuration, the first classification unit 2102 may enable specification of which element is non-zero and is to be used for the MTTKRP processing.

The second classification unit 2103 generates the third data on the basis of the acquired first data. The second classification unit 2103 groups, for example, each of combinations so that combinations with indexes of a target dimension discontinuous with each other are not included in the same group according to predetermined order with respect to the indexes of the target dimension. The predetermined order is, for example, ascending order or descending order. The second classification unit 2103 generates, for example, the third data that enables specification of a plurality of groups which corresponds to a predetermined number of parallels and is obtained by grouping.

For example, the second classification unit 2103 sorts the plurality of combinations so that the indexes of the target dimension are in ascending order. For example, the second classification unit 2103 divides the plurality of sorted combinations into a predetermined number of parallels from the beginning. For example, the second classification unit 2103 generates the third data that enables specification of the plurality of groups by using one or more divided combinations as one group. With this configuration, the second classification unit 2103 may enable specification of the plurality of groups that may be subjected to parallel processing, and may enable efficient performance of the MTTKRP processing.

The calculation unit 2104 performs, on the basis of the generated third data, the MTTKRP processing by setting the plurality of groups as a target of parallel processing in the MTTKRP processing related to the tensor data for the target dimension. For example, the calculation unit 2104 performs an operation on each combination of a plurality of combinations included in a group in predetermined order, and stores a result of the operation in a temporary area of the group. At this time, for example, the calculation unit 2104 reflects contents of the temporary area of the group to a solution matrix every time an operation on one or more combinations having the same indexes of the target dimension included in the group is completed.

With this configuration, the calculation unit 2104 may efficiently perform the MTTKRP processing. The calculation unit 2104 may promote reduction in calculation time. The calculation unit 2104 may avoid a calculation error in the MTTKRP processing. The calculation unit 2104 may further perform ALS processing on the basis of a result of performing the MTTKRP processing. With this configuration, the calculation unit 2104 may analyze the tensor data.

The calculation unit 2104 converts, for example, the first data into an array of structure (AoS) format. For example, the calculation unit 2104 refers to the first data after conversion, and performs, on the basis of the third data, the MTTKRP processing by setting the plurality of groups as the target of the parallel processing in the MTTKRP processing related to the tensor data for the target dimension. With this configuration, the calculation unit 2104 may promote improvement in calculation efficiency.

The output unit 2105 outputs a processing result of at least any one of the functional units. An output format is, for example, display on a display, print output to a printer, transmission to an external device by the network I/F 303, or storage in the storage area such as the memory 302 or the recording medium 305. With this configuration, the output unit 2105 enables notification of a processing result of at least any one of the functional units to the system administrator and may promote improvement in convenience of the information processing apparatus 100.

The output unit 2105 outputs, for example, a result of performing the MTTKRP processing. With this configuration, the output unit 2105 may facilitate performance of the ALS. The output unit 2105 outputs, for example, a result of performing the ALS processing. With this configuration, the output unit 2105 may enable a system user to refer to the result of performing the ALS processing, and may facilitate analysis of the tensor data.

Here, a case has been described where the information processing apparatus 100 includes the first classification unit 2102, the second classification unit 2103, and the calculation unit 2104. However, the embodiment is not limited to this. For example, there may be a case where the information processing apparatus 100 does not include the calculation unit 2104 and may be able to communicate with another computer including the calculation unit 2104. For example, in a case where the acquisition unit 2101 acquires the first data, the information processing apparatus 100 does not have to include the first classification unit 2102.

(Second Operation Example of Information Processing Apparatus 100)

Next, the second operation example of the information processing apparatus 100 will be described with reference to FIGS. 22 to 30.

FIGS. 22 to 30 are explanatory diagrams illustrating the second operation example of the information processing apparatus 100. In FIG. 22, the information processing apparatus 100 acquires first data 2200 in the COO format corresponding to three-dimensional tensor data. It is assumed that the respective dimensions are I, J, and K. The first data 2200 enables specification of attribute information of each of non-zero elements included in the three-dimensional tensor data. The first data 2200 is, for example, data in the SoA format.

The attribute information includes a value val of an element and indexes i, j, and k of the respective dimensions indicating a position of the element. The first data 2200 indicates attribute information of a non-zero element in each column. In the following description, attribute information including a value val of an element and indexes i, j, and k of the respective dimensions indicating a position of the element may be referred to as “attribute information (i, j, k, and val)”.

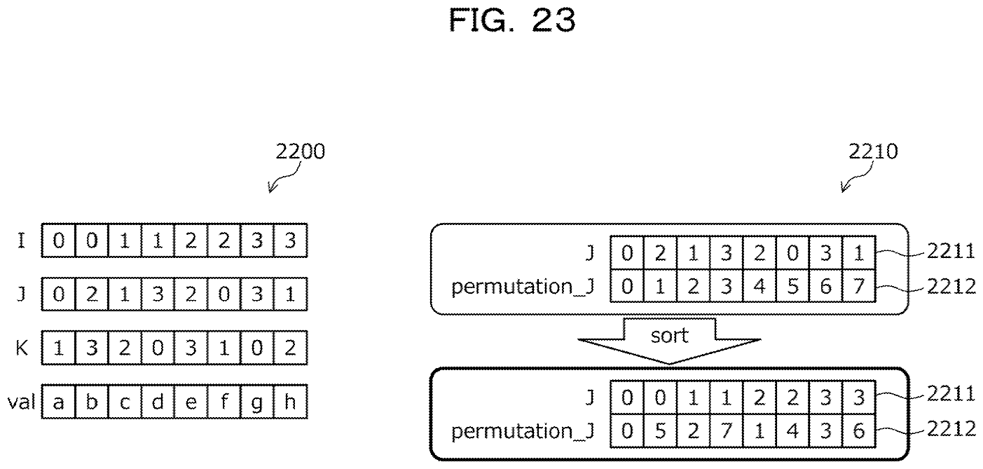

The information processing apparatus 100 sets the dimension J as a processing target, and prepares an array pair 2210 corresponding to the dimension J. The array pair 2210 includes an index array 2211 and a permutation array 2212. The index array 2211 is a one-dimensional array. In the index array 2211, the indexes j of the dimension J of the respective elements of the first data 2200 are set as values of the respective elements of the index array 2211 along order of appearance of the respective elements of the first data 2200. The permutation array 2212 is a one-dimensional array. In the permutation array 2212, integers of 0 or more are set in ascending order as values of the respective elements of the permutation array 2212. Next, description of FIG. 23 will be made.

In FIG. 23, the information processing apparatus 100 sorts the respective elements of the index array 2211 in ascending order. The information processing apparatus 100 sorts the respective elements of the permutation array 2212 according to the sorting of the respective elements of the index array 2211.

For example, in a case where an i-th element of the index array 2211 is moved to a j-th position, the information processing apparatus 100 similarly moves an i-th element of the permutation array 2212 to a j-th position. The information processing apparatus 100 deletes the index array 2211.

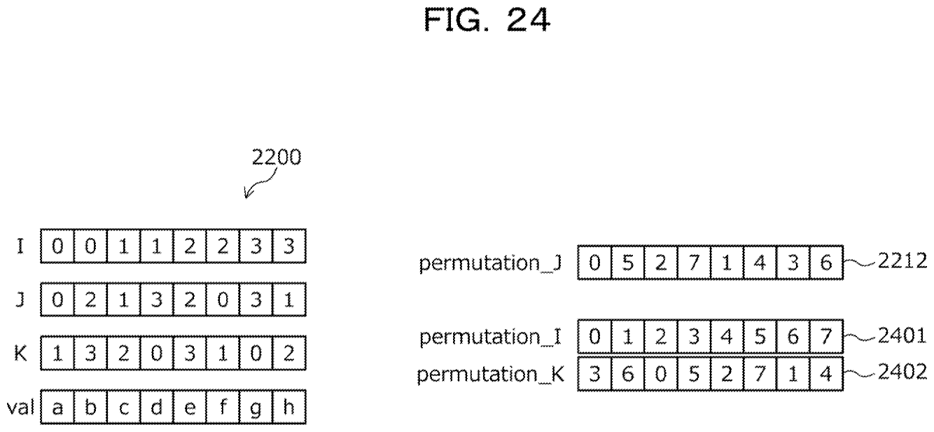

With this configuration, the information processing apparatus 100 may enable specification of the respective elements of the first data 2200 in ascending order of the indexes j of the dimension J by the permutation array 2212. Next, description of FIG. 24 will be made.

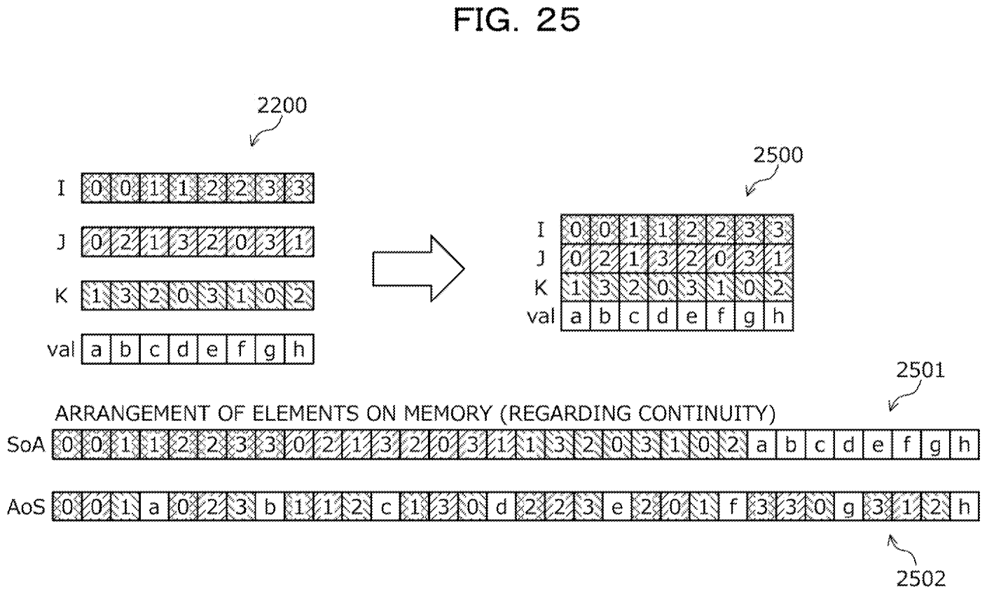

In FIG. 24, it is assumed that the information processing apparatus 100 sets the dimensions I and K as the processing targets and generates permutation arrays 2401 and 2402 in a similar manner to the case where the dimension J is set as the processing target. Next, description of FIG. 25 will be made.

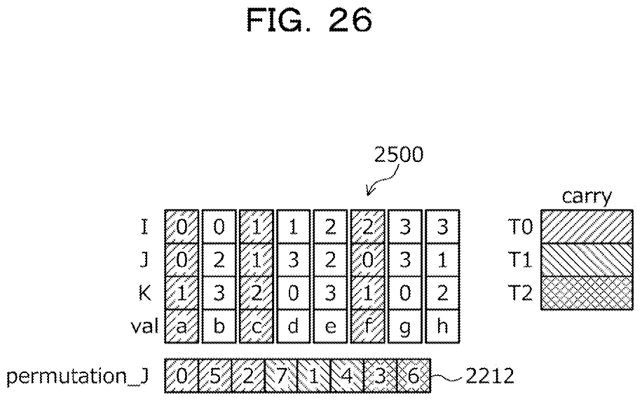

In FIG. 25, the information processing apparatus 100 converts the first data 2200 into data 2500 in the AoS format. In the first data 2200, the respective elements are arranged in a storage area in a manner indicated by arrangement 2501. On the other hand, in the data 2500, the respective elements are arranged in a storage area in a manner indicated by arrangement 2502. With this configuration, the information processing apparatus 100 may facilitate sequential access to the attribute information of the elements, and may promote improvement in access efficiency to the respective elements. Next, description of FIG. 26 will be made.

In FIG. 26, in order to perform the calculation of X₍₂₎(C⊚A) in the ALS by parallel processing, the information processing apparatus 100 prepares carry arrays which correspond to a predetermined number of parallels with the dimension J as the processing target. The predetermined number of parallels is a number that may be subjected to the parallel processing by the information processing apparatus 100. In the example of FIG. 26, the predetermined number of parallels is 3. The carry array is initialized to 0. The information processing apparatus 100 prepares, for example, a carry array T0, a carry array T1, and a carry array T2.

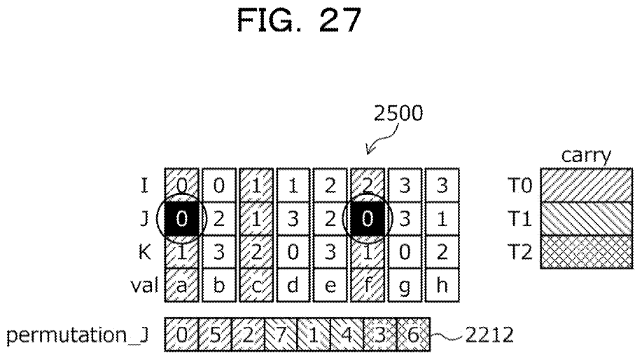

The information processing apparatus 100 classifies the respective elements of the permutation array 2212 into a plurality of groups which corresponds to a predetermined number of parallels as targets of parallel processing. The information processing apparatus 100 classifies, for example, first three elements into one group, subsequent three elements into one group, and last two elements into one group. With this configuration, the information processing apparatus 100 may specify, for example, a first element, a third element, and a sixth element in the data 2500, which are specified by the three elements classified in the same group, as processing units. Next, description of FIG. 27 will be made.

In FIG. 27, the information processing apparatus 100 handles each group in a different thread, and performs the calculation of X₍₂₎(C⊚A) in the ALS. The thread is executed by, for example, the information processing apparatus 100. The thread may be executed by, for example, other than the information processing apparatus 100. The information processing apparatus 100 performs, for example, calculation using three elements in the data 2500 specified by the first three elements of the permutation array 2212 classified into a first group by using the carry array T0 by a thread 0.

The information processing apparatus 100 selects, for example, the first element of the data 2500 on the basis of the first element classified into the first group by the thread 0. The information processing apparatus 100 stores, for example, a result of performing calculation for the selected first element in the calculation of X₍₂₎(C⊚A), in the carry array T0. The information processing apparatus 100 stores, for example, the index j of the dimension J of the first element as prev.

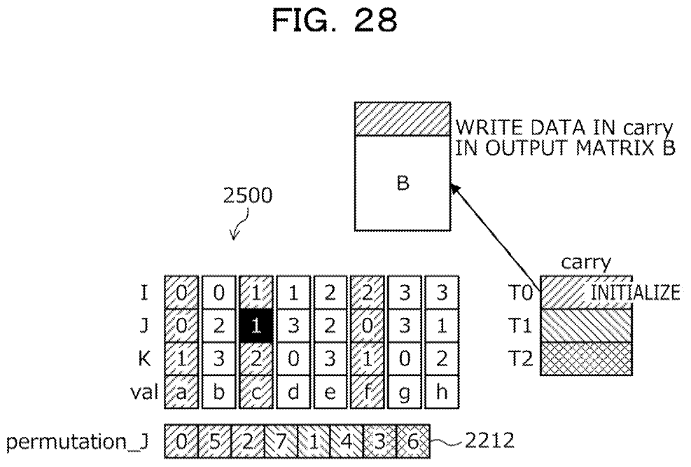

The information processing apparatus 100 selects, for example, the sixth element of the data 2500 on the basis of the second element classified into the first group by the thread 0. The information processing apparatus 100 determines, for example, whether or not the index j of the dimension J of the selected sixth element matches prev. For example, since the information processing apparatus 100 determines that the index j of the dimension J of the selected sixth element matches prev, the information processing apparatus 100 adds a result of performing calculation for the selected sixth element in the calculation of X₍₂₎(C⊚A) to the carry array T0 and stores the result. The information processing apparatus 100 stores, for example, the index j of the dimension J of the selected sixth element as prev. Next, description of FIG. 28 will be made.

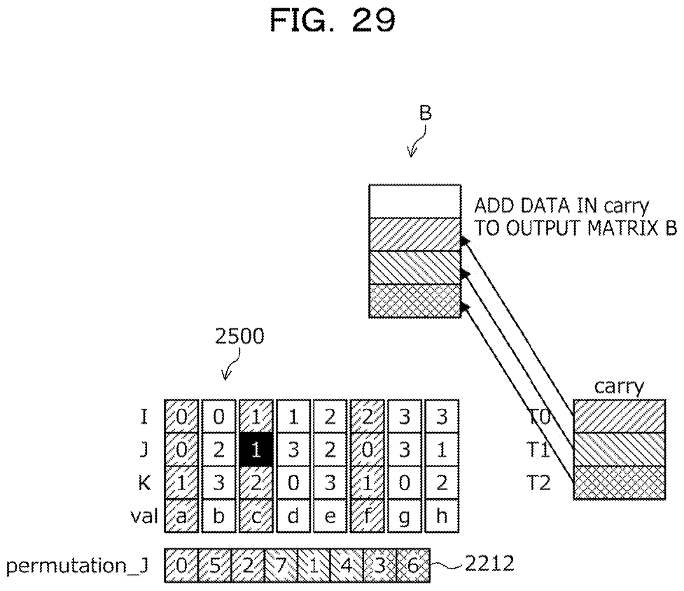

In FIG. 28, the information processing apparatus 100 selects, for example, the third element of the data 2500 on the basis of the third element classified into the first group by the thread 0. The information processing apparatus 100 determines, for example, whether or not the index j of the dimension J of the selected third element matches prev. For example, since the information processing apparatus 100 determines that the index j of the dimension J of the selected third element does not match prev, the information processing apparatus 100 writes contents of the carry array T0 in an output matrix B and stores the contents. Then, for example, the information processing apparatus 100 stores, after initializing the carry array T0, a result of performing calculation for the selected third element in the calculation of X₍₂₎(C⊚A), in the carry array T0. The information processing apparatus 100 stores, for example, the index j of the dimension J of the selected third element as prev. Next, description of FIG. 29 will be made.

In FIG. 29, for example, it is assumed that the information processing apparatus 100 performs calculation using three elements in the data 2500 by using the carry array T1 by a thread 1 in parallel with the thread 0, as in the case of the thread 0. Furthermore, for example, it is assumed that the information processing apparatus 100 performs calculation using three elements in the data 2500 by using the carry array T2 by a thread 2 in parallel with the thread 0, as in the case of the thread 0.

When the calculation by the thread 0, the thread 1, and the thread 2 is completed, the information processing apparatus 100 writes contents of the carry array T0, the carry array T1, and the carry array T2 in the output matrix B in order, and stores the contents. With this configuration, the information processing apparatus 100 may perform the calculation of X₍₂₎(C⊚A) in the ALS by parallel processing. Similarly, the information processing apparatus 100 may perform the calculation of X₍₁₎(C⊚B) in the ALS and the calculation of X₍₃₎(A⊚B) in the ALS. Thus, the information processing apparatus 100 may promote reduction in the calculation time taken for the MTTKRP processing.

For example, in the ALS, the information processing apparatus 100 may promote reduction in the calculation time and the memory usage taken for the MTTKRP processing such as the calculation of X₍₁₎(C⊚B), the calculation of X₍₂₎(C⊚A), and the calculation of X₍₃₎(A⊚B). Therefore, the information processing apparatus 100 may facilitate elimination of the bottleneck of the ALS, and may promote reduction in the calculation time taken for analyzing the tensor data by the ALS.

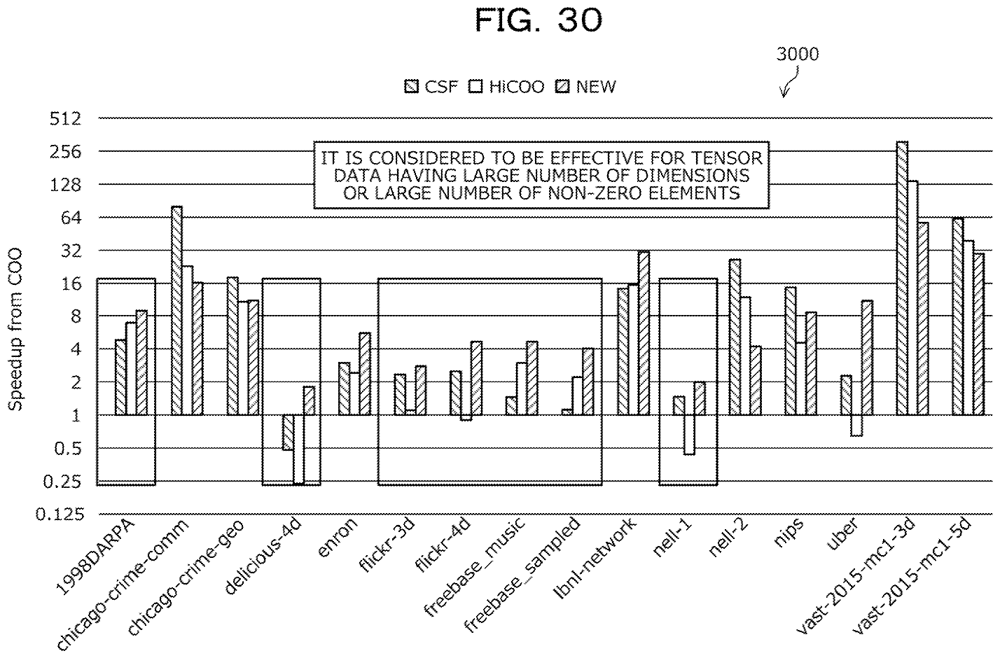

Furthermore, for example, the information processing apparatus 100 may avoid that different operations conflict with each other in the MTTKRP processing on the basis of the sorted permutation array, and may accurately perform the MTTKRP processing. Furthermore, the information processing apparatus 100 may promote averaging of a processing amount of each thread. Thus, the information processing apparatus 100 may enable efficient performance of the calculation of X₍₂₎(C⊚A) in the ALS. The information processing apparatus 100 may easily promote reduction in the calculation time taken for the MTTKRP processing regardless of the number of elements having overlapping indexes in the first data 2200. Next, description of FIG. 30 will be made.

FIG. 30 illustrates calculation efficiency in a case where the information processing apparatus 100 performs the ALS. For the calculation efficiency in a case where the information processing apparatus 100 performs the ALS, a graph 3000 of FIG. 30 indicates a magnification NEW based on calculation efficiency in a case where the ALS is performed by a prior method on data in the COO format. Furthermore, for calculation efficiency in a case where the ALS is performed by the prior method on data in the CSF format, the graph 3000 of FIG. 30 indicates a magnification based on calculation efficiency in a case where the ALS is performed by the prior method on data in the COO format. Furthermore, for calculation efficiency in a case where the ALS is performed by hierarchical coordinate (HiCOO), the graph 3000 of FIG. 30 indicates a magnification based on calculation efficiency in a case where the ALS is performed by the prior method on data in the COO format.

As indicated in the graph 3000 of FIG. 30, the information processing apparatus 100 may promote improvement in calculation efficiency of the ALS. Furthermore, as compared with the prior method, the information processing apparatus 100 may facilitate improvement in the calculation efficiency of the ALS based on the tensor data having a relatively large number of dimensions or a relatively large number of non-zero elements.

(Preparation Processing Procedure)

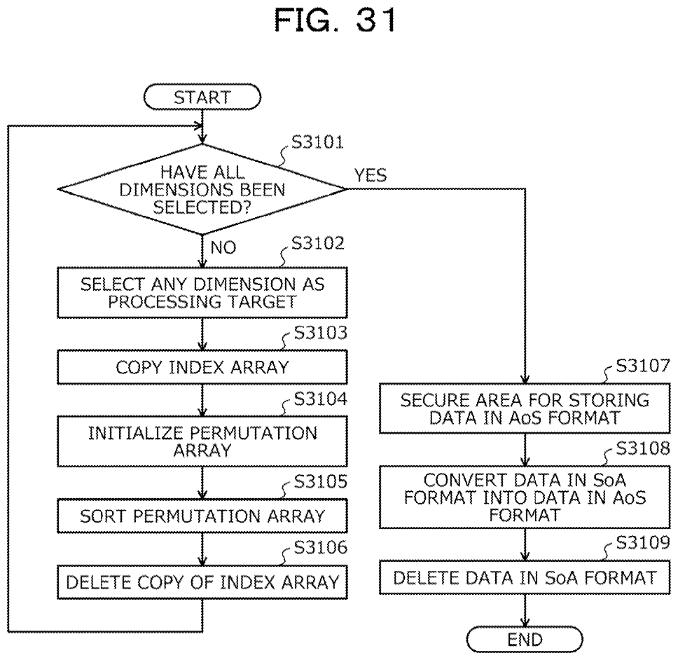

Next, one example of a preparation processing procedure executed by the information processing apparatus 100 will be described with reference to FIG. 31. Preparation processing is implemented by, for example, the CPU 301, the storage area such as the memory 302 or the recording medium 305, and the network I/F 303 illustrated in FIG. 3.

FIG. 31 is a flowchart illustrating one example of the preparation processing procedure. In FIG. 31, the information processing apparatus 100 determines whether or not all dimensions have been selected as processing targets (Step S3101). Here, in a case where all the dimensions have been selected (Step S3101: Yes), the information processing apparatus 100 proceeds to processing of Step S3107. On the other hand, in a case where a dimension that has not yet been selected remains (Step S3101: No), the information processing apparatus 100 proceeds to processing of Step S3102.

In Step S3102, the information processing apparatus 100 selects any dimension that has not yet been selected as a processing target as the processing target (Step S3102). Next, the information processing apparatus 100 copies an index array in which indexes of the selected dimension are arranged in order of appearance on data in the COO format (Step S3103). Then, the information processing apparatus 100 initializes a permutation array (Step S3104).

Next, the information processing apparatus 100 associates the copy of the index array with the permutation array, and sorts the permutation array on the basis of the copy of the index array (Step S3105). Then, the information processing apparatus 100 deletes the copy of the index array (Step S3106). Thereafter, the information processing apparatus 100 returns to the processing of Step S3101.

In Step S3107, the information processing apparatus 100 secures an area for storing data in the AoS format corresponding to tensor data (Step S3107). Next, the information processing apparatus 100 converts data in the SoA format corresponding to the tensor data into data in the AoS format (Step S3108). Then, the information processing apparatus 100 deletes the data in the SoA format corresponding to the tensor data (Step S3109). Thereafter, the information processing apparatus 100 terminates the preparation processing.

(Calculation Processing Procedure)

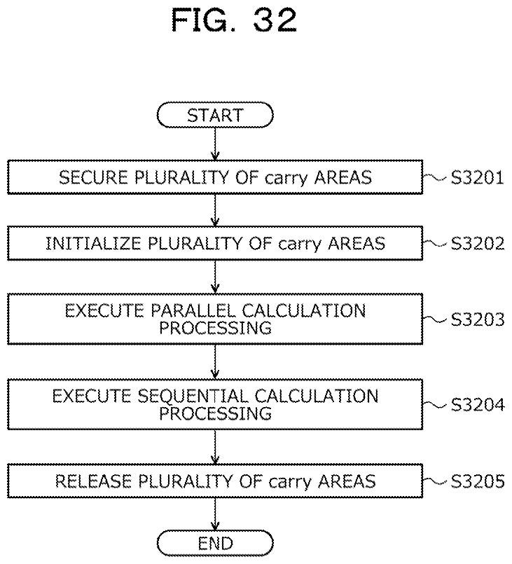

Next, one example of a calculation processing procedure executed by the information processing apparatus 100 will be described with reference to FIG. 32. Calculation processing is implemented by, for example, the CPU 301, the storage area such as the memory 302 or the recording medium 305, and the network I/F 303 illustrated in FIG. 3.

FIG. 32 is a flowchart illustrating one example of the calculation processing procedure. In FIG. 32, the information processing apparatus 100 secures a plurality of carry areas corresponding to the number of parallels (Step S3201).

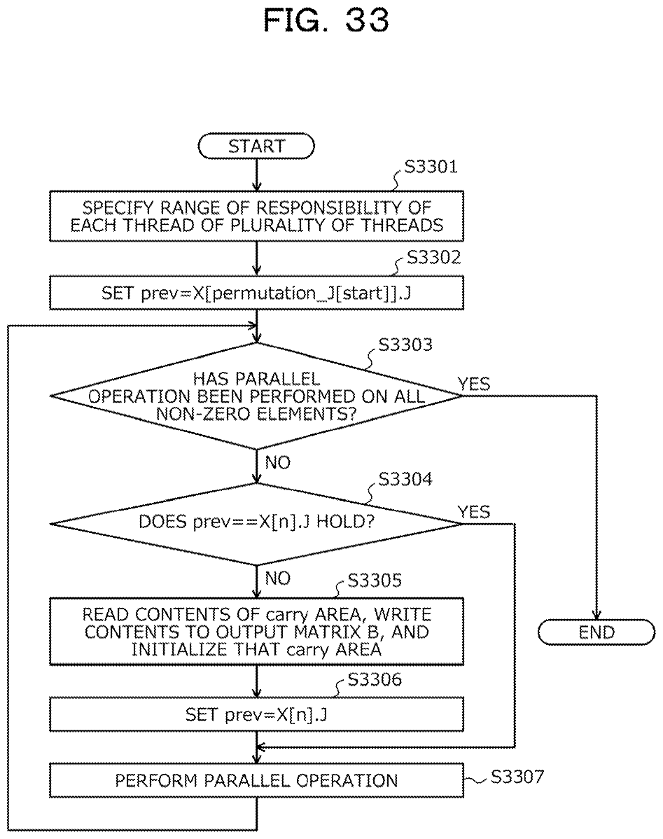

Next, the information processing apparatus 100 initializes the plurality of carry areas (Step S3202). Then, the information processing apparatus 100 executes parallel calculation processing described later with reference to FIG. 33 (Step S3203).

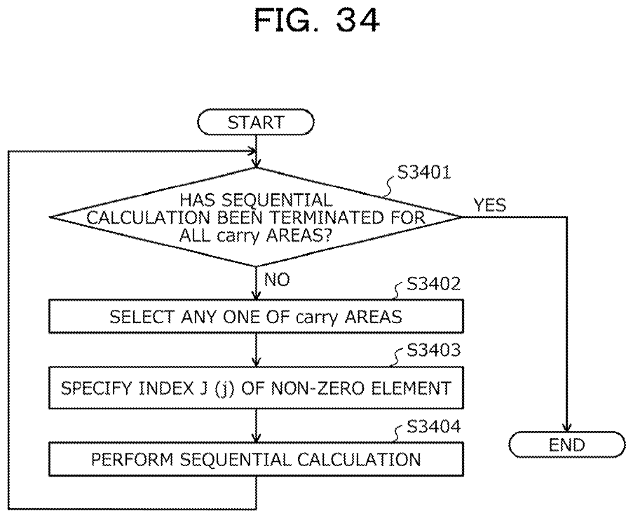

Next, the information processing apparatus 100 executes sequential calculation processing described later with reference to FIG. 34 (Step S3204). Then, the information processing apparatus 100 releases the plurality of carry areas (Step S3205). Thereafter, the information processing apparatus 100 terminates the calculation processing.

(Parallel Calculation Processing Procedure)

Next, one example of a parallel calculation processing procedure executed by the information processing apparatus 100 will be described with reference to FIG. 33. The parallel calculation processing is implemented by, for example, the CPU 301, the storage area such as the memory 302 or the recording medium 305, and the network I/F 303 illustrated in FIG. 3.

The parallel calculation processing indicated in FIG. 33 corresponds to the calculation of X₍₂₎(C⊚A). Since the parallel calculation processing corresponding to the calculation of X₍₁₎(C⊚B) and the calculation of X₍₃₎(A⊚B) is similar to the parallel calculation processing indicated in FIG. 33, description thereof is omitted.

FIG. 33 is a flowchart illustrating one example of the parallel calculation processing procedure. In FIG. 33, the information processing apparatus 100 specifies a range of responsibility of each thread of a plurality of threads corresponding to the number of parallels on the basis of a sorted permutation array (Step S3301).

Next, the information processing apparatus 100 sets prev=X[permutation_J[start]]·J for each thread (Step S3302). For prev, for example, an index of a non-zero element immediately before or first accessed is set. X[ ]·J indicates the index j of the dimension J of any element of data in the AoS format. permutation_J[start] indicates a first element of a permutation array.

Then, the information processing apparatus 100 determines whether or not a parallel operation has been performed on all non-zero elements included in the range of responsibility of each thread (Step S3303). Here, in a case where the parallel operation has been performed on all the non-zero elements (Step S3303: Yes), the information processing apparatus 100 terminates the parallel calculation processing. On the other hand, in a case where the parallel operation has not been performed on any one of the non-zero elements (Step S3303: No), the information processing apparatus 100 proceeds to processing of Step S3304.

In Step S3304, the information processing apparatus 100 determines whether or not prev==X[n]·J holds for an n-th non-zero element (n) included in the range of responsibility of at least any one of the threads (Step S3304). Here, in a case where prev==X[n]·J holds (Step S3304: Yes), the information processing apparatus 100 proceeds to processing of Step S3307. On the other hand, in a case where prev==X[n]·J does not hold (Step S3304: No), the information processing apparatus 100 selects the thread for which it is determined that prev==X[n]·J does not hold, and proceeds to processing of Step S3305.

In Step S3305, the information processing apparatus 100 reads contents of a carry area corresponding to the selected thread, writes the contents to the output matrix B, and initializes the carry area (Step S3305). Next, the information processing apparatus 100 sets prev=X[n]·J for the selected thread (Step S3306). Then, the information processing apparatus 100 proceeds to the processing of Step S3307.

In Step S3307, the information processing apparatus 100 performs the parallel operation (Step S3307). The information processing apparatus 100 performs the parallel operation by, for example, in the carry area corresponding to each thread, causing the thread to perform a predetermined operation using an n-th non-zero element (n) included in the range of responsibility of the thread. The parallel operation is defined by, for example, the following Expression (6). Then, the information processing apparatus 100 returns to the processing of Step S3303.

for f in F:B[X[n]·J,f]+=X[n]·val*C[X[n]·K,f]*A[X[n]·I,f] (6)

(Sequential Calculation Processing Procedure)

Next, one example of a sequential calculation processing procedure executed by the information processing apparatus 100 will be described with reference to FIG. 34. The sequential calculation processing is implemented by, for example, the CPU 301, the storage area such as the memory 302 or the recording medium 305, and the network I/F 303 illustrated in FIG. 3.

The sequential calculation processing indicated in FIG. 34 corresponds to the calculation of X₍₂₎(C⊚A). Since the sequential calculation processing corresponding to the calculation of X₍₁₎(C⊚B) and the calculation of X₍₃₎(A⊚B) is similar to the sequential calculation processing indicated in FIG. 34, description thereof is omitted.

FIG. 34 is a flowchart illustrating one example of the sequential calculation processing procedure. In FIG. 34, the information processing apparatus 100 determines whether or not sequential calculation has been terminated for all carry areas (Step S3401). Here, in a case where the sequential calculation has been terminated for all the carry areas (Step S3401: Yes), the information processing apparatus 100 terminates the sequential calculation processing. On the other hand, in a case where the sequential calculation has not been terminated for any one of the carry areas (Step S3401: No), the information processing apparatus 100 proceeds to processing of Step S3402.

In Step S3402, the information processing apparatus 100 selects any one of the carry areas for which the sequential calculation has not yet been terminated (Step S3402). Next, the information processing apparatus 100 specifies an index J (j) of a non-zero element last calculated by a thread responsible for the selected carry area (Step S3403).

Then, the information processing apparatus 100 performs the sequential calculation by causing, for the carry area corresponding to each thread, the thread to perform a predetermined operation (Step S3404). The sequential calculation is defined by, for example, the following Expression (7). tid is an identification (ID) of the thread.

for f in F:B[r][f]+=carry[tid][f] (7)

As described above, according to the information processing apparatus 100, it is possible to acquire first data that enables, for each of non-zero elements included in multidimensional tensor data, specification of a combination of a value of the element and an index of each dimension indicating a position of the element. According to the information processing apparatus 100, it is possible to generate, on the basis of the first data, second data that enables specification of a plurality of groups obtained by grouping each of the combinations so that the combinations with indexes overlapping with each other are included in different groups. According to the information processing apparatus 100, it is possible to perform, on the basis of the generated second data, MTTKRP processing by setting each combination of a plurality of combinations included in the group as a target of parallel processing in the MTTKRP processing related to the tensor data. With this configuration, the information processing apparatus 100 may perform parallel processing on operations different from each other in the MTTKRP processing while avoiding that the different operations conflict with each other for each dimension. Thus, the information processing apparatus 100 may promote reduction in calculation time and memory usage taken for the MTTKRP processing.

According to the information processing apparatus 100, it is possible to acquire the first data by generating the first data on the basis of the tensor data. With this configuration, the information processing apparatus 100 may dispense with the need for a system user or a system administrator to generate the first data. The information processing apparatus 100 may promote reduction in a processing load applied on the system user or the system administrator.

According to the information processing apparatus 100, it is possible to generate, as the second data, a multidimensional array formed by arranging a one-dimensional array indicating each of the combinations included in the group for each group. According to the information processing apparatus 100, the second data may include a pointer that specifies any one of the combinations included in the group so that the group may be divided. With this configuration, the information processing apparatus 100 may generate the second data in a format similar to that of the first data, and may improve convenience of the second data.

According to the information processing apparatus 100, it is possible to acquire the tensor data. According to the information processing apparatus 100, it is possible to determine whether or not each of elements included in the tensor data is non-zero. According to the information processing apparatus 100, it is possible to generate the second data on the basis of a result of the determination. With this configuration, the information processing apparatus 100 may avoid leaving the first data in a storage area, and may promote reduction in memory usage.

Note that the information processing method described in the present embodiment may be implemented by executing a program prepared in advance, on a computer such as a PC or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
acquiring first data that enables, for each of non-zero elements included in multidimensional tensor data, specification of a combination of a value of the element and an index of each dimension that indicates a position of the element;
generating, on the basis of the acquired first data, second data that enables specification of a plurality of groups obtained by grouping each of the combinations such that the combinations with indexes that overlap with each other are included in different groups; and
performing, on the basis of the generated second data, matricized tensor times khatri-rao product (MTTKRP) processing by setting each combination of a plurality of combinations included in the group as a target of parallel processing in the MTTKRP processing related to the tensor data.

2. The non-transitory computer-readable recording medium according to claim 1, wherein
in the processing of acquiring,
the first data is acquired by generating the first data on the basis of the tensor data.

3. The non-transitory computer-readable recording medium according to claim 1, wherein the second data is a multidimensional array formed by arranging a one-dimensional array that indicates each of the combinations included in the group for each group, and includes a pointer that specifies any one of the combinations included in the group such that division of the group is possible.

4. The non-transitory computer-readable recording medium according to claim 1, further causing the computer to execute processing comprising:
acquiring the tensor data; and
determining whether or not each of elements included in the tensor data is non-zero,
wherein, in the processing of generating,
the second data is generated on the basis of a result of the determination.

5. The non-transitory computer-readable recording medium according to claim 1, further causing the computer to execute processing comprising:
generating, on the basis of the acquired first data, third data that enables specification of a plurality of groups that corresponds to a predetermined number of parallels obtained by grouping each of the combinations such that the combinations with indexes of a target dimension discontinuous with each other are not included in the same group according to predetermined order with respect to the indexes of the target dimension; and
performing, on the basis of the generated third data, the MTTKRP processing by setting the plurality of groups as targets of the parallel processing in the MTTKRP processing related to the tensor data for the target dimension, performing an operation on each combination of a plurality of combinations included in the group in the predetermined order, storing a result of the operation in a temporary area of the group, and reflecting contents of the temporary area of the group to a solution matrix every time an operation on one or more combinations that have the same indexes of the target dimension included in the group is completed.

6. The non-transitory computer-readable recording medium according to claim 5, wherein the predetermined order is ascending order or descending order of the indexes of the target dimension.

7. The non-transitory computer-readable recording medium according to claim 5, wherein
in the processing of performing,
the combination is stored in an array of structure format, and the MTTKRP processing is performed.

8. An information processing method comprising:
acquiring, by a computer, first data that enables, for each of non-zero elements included in multidimensional tensor data, specification of a combination of a value of the element and an index of each dimension that indicates a position of the element;
generating, on the basis of the acquired first data, second data that enables specification of a plurality of groups obtained by grouping each of the combinations such that the combinations with indexes that overlap with each other are included in different groups; and
performing, on the basis of the generated second data, matricized tensor times khatri-rao product (MTTKRP) processing by setting each combination of a plurality of combinations included in the group as a target of parallel processing in the MTTKRP processing related to the tensor data.

9. A non-transitory computer-readable recording medium storing an information processing program for causing a computer to execute processing comprising:
acquiring first data that enables, for each of non-zero elements included in multidimensional tensor data, specification of a combination of a value of the element and an index of each dimension that indicates a position of the element;
generating, on the basis of the acquired first data, second data that enables specification of a plurality of groups that corresponds to a predetermined number of parallels obtained by grouping each of the combinations such that the combinations with indexes of a target dimension discontinuous with each other are not included in the same group according to predetermined order with respect to the indexes of the target dimension; and
performing, on the basis of the generated second data, matricized tensor times khatri-rao product (MTTKRP) processing by setting the plurality of groups as targets of parallel processing in the MTTKRP processing related to the tensor data for the target dimension, performing an operation on each combination of a plurality of combinations included in the group in the predetermined order, storing a result of the operation in a temporary area of the group, and reflecting contents of the temporary area of the group to a solution matrix every time an operation on one or more combinations that have the same indexes of the target dimension included in the group is completed.
